(19) United States
(12) Patent Application Publication
(10) Pub. No.: US 2014/0309416 A1
(43) Pub. Date: Oct. 16, 2014

(54) EFFICIENT USE OF IONIC LIQUIDS

(71) Applicant: HYRAX ENERGY INC., Mountain View, CA (US)

(72) Inventors: Rodrigo E. Teixeira, Palo Alto, CA (US); Kurtis G. Knapp, Mountain View, CA (US); Travis A. Fixmer, Moses Lake, WA (US)

(73) Assignee: HYRAX ENERGY INC., Mountain View, CA (US)

(21) Appl. No.: 14/343,832

(22) PCT Filed: Sep. 7, 2012
(86) PCT No.: PCT/US2012/054302

§ 371 Date: Jul. 2, 2014

Related U.S. Application Data
(60) Provisional application No. 61/532,941, filed on Sep. 9, 2011.
(60) Provisional application No. 61/621,764, filed on Apr. 9, 2012.

(51) Int. Cl. C13K 1/04

(52) U.S. Cl. CPC C13K 1/04
USPC 536/127; 252/182.12

(57) ABSTRACT

In one aspect, provided herein are efficient methods for using ionic liquids. In some embodiments, only a small amount of ionic liquid is lost in a chemical process. For example, described herein is a method for separating one or more biomass components from an ionic liquid comprising contacting a composition comprising an ionic liquid and a biomass component with a fluid.

### CROSS-REFERENCE

This application claims the benefit of U.S. Provisional Application No. 61/532,941 filed on Sep. 9, 2011 and U.S. Provisional Application No. 61/621,764 filed on Apr. 9, 2012, each of which is incorporated herein by reference in its entirety.

### BACKGROUND

Ionic liquids are salts (e.g., comprising cations and anions) that are a liquid. Interest has grown regarding using ionic liquids in various chemical processes. In some applications, ionic liquids can be used to dissolve material (e.g., cellulosic biomass). In some applications, ionic liquids can be used as a catalyst. Realization of the potential benefits of chemical processes based on ionic liquids has been limited by the high cost of ionic liquids.

### SUMMARY

In an aspect, provided herein are efficient methods for using ionic liquids. In some embodiments, only a small amount of ionic liquid is lost in a chemical process. For example, described herein is a method for separating one or more biomass components from an ionic liquid comprising contacting a composition comprising an ionic liquid and a biomass component with a fluid, wherein less than 10 grams of ionic liquid is lost per kilogram of biomass component separated.

The one or more biomass components (e.g., sugar, oils, amino acids, and derivatives thereof) can be derived from cellulosic biomass.

In an aspect, provided herein is a method for extracting one or more biomass components comprising contacting a composition comprising one or more biomass components in an ionic liquid with a supercritical or near-supercritical fluid. In some embodiments, the method further comprises recovering the extracted one or more biomass components from the supercritical or near-supercritical fluid.

In some embodiments, the composition comprising one or more biomass components in an ionic liquid is obtained by dissolving a biomass in an ionic liquid and hydrolyzing the biomass in the ionic liquid. In some embodiments, the one or more biomass components comprise sugars, furanic compounds, lipids, ash, fatty acids, resin acids, waxes, terpenes, acetates, acetic acids, alcohols, amino acids, sugar acids, phenols, aldehydes, ethers or combinations thereof.

In some embodiments, the one or more biomass components are recovered from the supercritical or near-supercritical fluid using supercritical chromatography. In some embodiments, the one or more biomass components are recovered from the supercritical or near-supercritical fluid by lowering the pressure of the fluid. In some embodiments, the pressure is not lowered below the critical pressure of the supercritical or near-supercritical fluid. In some embodiments, the one or more biomass components are recovered from the supercritical or near-supercritical fluid by lowering the temperature of the fluid. In some embodiments, the one or more biomass components are recovered from the supercritical or near-supercritical fluid by raising the temperature of the fluid.

In some embodiments, the one or more biomass components are sequentially extracted from the ionic liquid in a plurality of supercritical or near-supercritical fluids.

In some embodiments, the supercritical or near-supercritical fluid comprises a co-solvent. In some embodiments, the co-solvent is selected from water, alcohol, acetic acid, acetate, acetone, carboxylic acids, organic polar acids or any combination thereof. In some embodiments, the co-solvent is derived from the biomass.

In some embodiments, the supercritical or near-supercritical fluid is methane, ethane, propane, ethylene, propylene, nitrogen, hydrogen, helium, argon, oxygen, nitrous oxide, or any combination thereof. In some embodiments, the supercritical or near-supercritical fluid is carbon dioxide.

In some embodiments, the biomass components comprise carbohydrates, the molecular weight of the carbohydrates is reduced in the ionic liquid to form sugars, and the sugars arc extracted from the ionic liquid.

In some embodiments, ionic liquid is rejected from the supercritical or near-supercritical fluid by increasing the pressure of the fluid following extraction and before recovery of the biomass components from the fluid.

In some embodiments, water is extracted from the composition in the supercritical or near-supercritical fluid.

In an aspect, provided herein is a method for extracting a biomass component from an ionic liquid mixture comprising contacting an ionic liquid mixture containing a biomass component with a supercritical fluid to form a post-extraction supercritical fluid mixture and a post-extraction ionic liquid mixture, wherein the post-extraction ionic liquid mixture has less amount of the biomass component than the amount contained in the ionic liquid mixture, wherein the post-extraction supercritical fluid mixture has more amount of the biomass component than the amount contained in the supercritical fluid.

In some embodiments, the post-extraction supercritical fluid mixture has a pressure such that ionic liquid is rejected from the post-extraction supercritical fluid mixture. In some embodiments, water is extracted from the ionic liquid mixture into the post-extraction supercritical fluid mixture.

In an aspect, provided herein is a method for extracting one or more biomass components comprising contacting a solution comprising one or more biomass components in an ionic liquid with a fluid, wherein substantially none of the ionic liquid dissolves in the fluid, and wherein at least some of the biomass components dissolve in the fluid.

In an aspect, provided herein is a method for extracting one or more biomass components comprising contacting a solution comprising one or more biomass components in an ionic liquid with a fluid, wherein at least some of the biomass components dissolve in the fluid, and increasing the pressure so that substantially none of the ionic liquid dissolves in the fluid.

In some embodiments, the fluid is miscible in the ionic liquid. In some embodiments, the fluid is a supercritical or near-supercritical fluid.

In an aspect, provided herein is a method for recovering biomass components from an ionic liquid comprising contacting a composition comprising an ionic liquid, water and a hydrogen bonding solute with a fluid to form a first phase comprising an ionic liquid and a second phase comprising water and the hydrogen bonding solute. In some embodiments, the method further comprises partitioning the second phase from the first phase. In some embodiments, contacting the composition with the fluid forms a third phase comprising the fluid.

In some embodiments, the hydrogen bonding solute is derived from biomass. In some embodiments, the hydrogen bonding solute has at least one hydroxyl group. In some embodiments, the hydrogen bonding solute comprises sugar, an aldose, a ketose, or any combination thereof.

In some embodiments, the ionic liquid is hydrophilic.

In some embodiments, the fluid is a pressurized gas. In some embodiments, the fluid is a liquefied gas. In some embodiments, the fluid is a supercritical or near-supercritical fluid. In some embodiments, the fluid is non-polar. In some embodiments, fluid comprises carbon dioxide.

In some embodiments, the composition is contacted with the fluid at a pressure greater than atmospheric pressure.

In some embodiments, contacting the composition with the fluid decreases the viscosity of the composition. In some embodiments, the viscosity of the first phase is less than the viscosity of the composition without contact with the fluid.

In some embodiments, the dielectric constant of the first phase is less than the dielectric constant of the ionic liquid.

In some embodiments, the concentration of the water in the hydrolysis reaction is such that the concentration of the hydrogen bonding solute in the second phase is near saturation. In some embodiments, water is added to the hydrolysis reaction at a rate such that the concentration of ionic liquid in the second phase is less than 25% (w/w).

In an aspect, provided herein is a method for recovering biomass components from an ionic liquid, the method comprising forming a first phase and a second phase from a hydrolyzed biomass composition comprising an ionic liquid, water and one or more biomass components, wherein the first phase comprises an ionic liquid and the second phase comprises water and one or more biomass components.

In some embodiments, the hydrolyzed biomass composition is obtained by hydrolyzing the biomass and/or biomass component in the ionic liquid. In some embodiments, the biomass component is a sugar. In some embodiments, the sugar comprises glucose.

In some embodiments, the sugar at least partially stabilizes the second phase.

In some embodiments, the concentration of the water in the hydrolysis reaction is such that the concentration of the sugar in the second phase is near saturation. In some embodiments, water is added to the hydrolysis reaction at a rate such that the concentration of ionic liquid in the second phase is less than 25% (w/w).

In some embodiments, the composition is pressurized to form the first phase and the second phase. In some embodiments, the temperature of the composition is reduced to form the first phase and the second phase. In some embodiments, the composition is contacted with pressurized carbon dioxide to form the first phase and the second phase.

In some embodiments, the hydrolysis of biomass provides solutes that induce the formation of the first phase and the second phase. In some embodiments, the solutes comprise sugar, oil, methanol, or any combination thereof.

In an aspect, provided herein is a method for separating water and a hydrogen bonding solute from a composition comprising an ionic liquid, water and hydrogen bonding solute, wherein the ratio of the mass of water to the mass of hydrogen bonding solute when separated is approximately equal to the ratio of the mass of water to the mass of hydrogen bonding solute in the composition.

In some embodiments, the ratio of the mass of water to the mass of hydrogen bonding solute when separated is within about 20% of the ratio of the mass of water to the mass of hydrogen bonding solute in the composition.

In an aspect, provided herein is a method for separating hydrogen bonding solute from a composition comprising an ionic liquid and hydrogen bonding solute, wherein the concentration of the ionic liquid increases when the hydrogen bonding solute is separated from the composition.

In some embodiments, the ionic liquid is not diluted in the separation. In some embodiments, the separation does not comprise concentrating the ionic liquid by evaporating water.

In an aspect, provided herein is a method for separating water and hydrogen bonding solute from a composition comprising an ionic liquid, water and hydrogen bonding solute, wherein the hydrogen bonding solute is separated from the ionic liquid at a concentration of at least 10% (w/w).

In an aspect, provided herein is a method for separating a solute from an ionic liquid comprising reducing the dielectric constant of a composition comprising an ionic liquid and a solute by contacting the composition with a pressurized gas.

In some embodiments, the solute is precipitated from the ionic liquid. In some embodiments, the solute comprises sugar.

In an aspect, provided herein is a method for producing fermentable sugar comprising hydrolyzing a polysaccharide in an ionic liquid to produce sugar and continuously removing the sugar from the ionic liquid.

In an aspect, provided herein is a method for producing fermentable sugar comprising hydrolyzing a polysaccharide in an ionic liquid to produce sugar and continuously cooling the hydrolysate.

In some embodiments, the mass of furanic compounds produced is less than 1% of the mass of sugar produced in the ionic liquid. In some embodiments, the sugar is removed from the ionic liquid at an optionally variable rate such that the mass of furanic compounds produced is less than 1% of the mass of sugar produced in the ionic liquid.

In some embodiments, the rate of sugar removal from the ionic liquid is approximately equal to the rate of sugar production. In some embodiments, the sugar is continuously removed by extraction in a supercritical or near-supercritical fluid. In some embodiments, the sugar is fermentable when removed from the ionic liquid.

In an aspect, provided herein is a composition comprising an ionic liquid, a pressurized gas, water and a biomass.

In an aspect, provided herein is a multi-phasic system comprising (a) a first phase comprising a pressurized gas, water and one or more biomass components; and (b) a second phase comprising an ionic liquid and one or more biomass components.

In an aspect, provided herein is a multi-phasic system comprising (a) a first phase comprising a pressurized gas, water and one or more biomass components; (b) a second phase comprising a pressurized gas, water, one or more biomass components and an ionic liquid; and (c) a third phase comprising an ionic liquid and one or more biomass components.

In some embodiments, the pressurized gas is a supercritical or near-supercritical fluid. In some embodiments, the first phase comprises less than about 0.5% ionic liquid.

In an aspect, provided herein is multi-phasic system comprising (a) a first phase comprising an ionic liquid; (b) a second phase comprising water and one or more biomass components; and (c) optionally a third phase comprising a fluid.

In some embodiments, the fluid is a pressurized gas. In some embodiments, the fluid is a liquefied gas. In some embodiments, the second phase comprises less than about 25% ionic liquid.

In an aspect, provided herein is a method for recovering a furanic compound from an ionic liquid comprising: contacting a composition comprising a furanic compound and an ionic liquid with a fluid.

In some embodiments, the composition comprising a furanic compound is produced by contacting an ionic liquid with a biomass, a polysaccharide, a sugar, or a combination thereof. In some embodiments, the furanic compound is hydroxymethylfurfural, 2,5-dimethylfuran, furfural, or a combination thereof. In some embodiments, the ionic liquid further comprises a catalyst.

In some embodiments, the fluid is a pressurized gas, liquefied gas, or supercritical or near-supercritical fluid. In some embodiments, the furanic compound is extracted in the supercritical or near-supercritical fluid.

In some embodiments, contacting the ionic liquid with a fluid forms a first phase comprising the ionic liquid and a second phase comprising the furanic compound and the furanic compound is recovered from the ionic liquid by partitioning the second phase from the first phase. In some embodiments, the ionic liquid comprises water, contact with the fluid creates an aqueous phase, and the furanic compound is recovered in the aqueous phase. In some embodiments, the ionic liquid comprises water, contact with the fluid creates an organic phase, and the furanic compound is recovered in the organic phase.

In an aspect, provided herein is a method for manufacturing or purifying an ionic liquid, comprising removing non-ionic components from the ionic liquid by contacting the ionic liquid with a pressurized gas.

In some embodiments, the method further comprises synthesizing the ionic liquid by mixing ionic components prior to removing non-ionic components from the ionic liquid.

In some embodiments, the method further comprises synthesizing the ionic liquid by creating ionic components in a reaction prior to removing non-ionic components from the ionic liquid.

In an aspect, provided herein is a method for separating a sugar from an ionic liquid comprising contacting a composition comprising an ionic liquid and a biomass component with a fluid, wherein less than 10 grams of ionic liquid is lost per kilogram of biomass component separated. In some embodiments, less than 1 gram of ionic liquid is lost per kilogram of biomass component separated. In some embodiments, less than 0.1 gram of ionic liquid is lost per kilogram of biomass component separated.

In an aspect, provided herein is a sugar composition comprising water, a sugar and carbon dioxide, wherein the sugar is derived from cellulose, hemicellulose, or a combination thereof.

In some embodiments, the sugar composition further comprises ionic liquid. In some embodiments, the concentration of ionic liquid is detectable and less than 1%.

In an aspect, provided herein is a sugar composition comprising water, a sugar and an ionic liquid, wherein the sugar is derived from cellulose, hemicellulose, or a combination thereof.

In some embodiments, the sugar composition further comprises carbon dioxide. In some embodiments, the concentration of carbon dioxide is detectable and less than 1%.

In an aspect, provided herein is a fermentable sugar comprising a sugar and an ionic liquid, wherein the mass of sugar is at least 20 times greater than the mass of the ionic liquid, and wherein the sugar is derived from cellulose, hemicellulose, or a combination thereof.

In some embodiments, the sugar comprises at least one component selected from furanics, phenols, ethers, aldehydes, ash, lignin, and lignin derivatives. In some embodiments, the concentration of at least one of: furanics, phenols, ethers, aldehydes, ash, lignin, and lignin derivatives, or any combination thereof is less than 1% (w/w).

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

A better understanding of the features and advantages of the present invention will be obtained by reference to the following detailed description that sets forth illustrative embodiments, in which the principles of the invention are utilized, and the accompanying drawings of which:

FIG. 1 shows an exemplary multi-phasic system.

FIG. 2 shows an exemplary multi-phasic system.

FIG. 3 shows an exemplary method for extracting a biomass component from an ionic liquid mixture.

FIG. 4 shows an example of recovering one or more biomass components from a fluid.

FIG. 5 shows an example of extracting biomass components from an ionic liquid using two sequential fluid extractions.

FIG. 6 shows an example of pressurizing a fluid to reject ionic liquid from the fluid when extracting biomass components from an ionic liquid.

FIG. 7 shows an example of recovering biomass components from an ionic liquid by forming an aqueous phase.

FIG. 8 shows an example of recovering biomass components from an ionic liquid by contacting the ionic liquid with a fluid to form an aqueous phase.

FIG. 9 is a picture of a solution of ionic liquid, water and glucose after extraction with supercritical carbon dioxide.

FIG. 10 is a picture of a product collected from a supercritical extraction of glucose from ionic liquid using carbon dioxide and water co-solvent.

FIG. 11 is a picture of a collection vessel filling with vapor during a supercritical extraction of glucose from carbon dioxide with water co-solvent.

FIG. 12 is a picture of the fluid captured during a supercritical extraction of glucose from carbon dioxide with water co-solvent.

FIG. 13 is a picture of precipitate forming during drying of collected liquid extract during a supercritical extraction of glucose from carbon dioxide with water co-solvent.

FIG. 14 is a picture of an aqueous phase and an ionic liquid phase with a glucose solute.

FIG. 15 shows a graph of the recovery of glucose in an aqueous phase from an ionic liquid-glucose solution.

FIG. 16 shows a logarithmic graph of the recovery of glucose in an aqueous phase from an ionic liquid-glucose solution.

FIG. 17 shows the formation of an aqueous phase over time.

FIG. 18 is a picture of an aqueous phase and an ionic liquid phase.

FIG. 19 shows an exemplary glucose concentration in a water phase over time period of being in contact with an ionic liquid-water-glucose solution.

FIG. 20 shows a relationship between ionic liquid concentration and conductivity.

FIG. 21 shows the conductivity and ionic liquid concentration after 12 hours of a water phase added on top of an ionic liquid-water-glucose solution.

FIG. 22 shows various frames of a video showing an aqueous phase and an ionic liquid phase in the presence of a glucose solute.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

### Ionic Liquids

An “ionic liquid” (“IL”) refers to salts (e.g., comprising cations and anions) that are liquid. In some cases, the ionic liquid is a liquid at the conditions (e.g., temperature, presence of materials mixed with the ionic liquid) used in the process. Ionic liquids can have a relatively low melting point (e.g., are liquid at temperatures below a certain low temperature). In some cases, the melting point is below about 300° C., below about 200° C., below about 150° C., below about 130° C., below about 100° C., below about 75° C., below about 50° C., and the like. In some embodiments, the ionic liquid is a liquid at ambient and/or room temperature. The melting point can refer to the melting point of the pure (e.g., at least 90% pure, at least 95% pure, at least 96% pure, at least 97% pure, at least 98% pure, at least 99% pure) ionic liquid, or can refer to the melting point of the ionic liquid when mixed with other components as used in the process (e.g., water). Mixtures of one or more ionic liquids can also be used. In some embodiments, a mixture of 1, 2, 3, 4, 5 or more ionic liquids can be used.

For example, 1-butyl-3-methylimidazolium chloride, which has an anion, a cation, and a melting point of about 65° C. is an ionic liquid. In some cases, the term “molten salt” is used interchangeably with ionic liquid. In some cases, a molten salt is not an ionic liquid (e.g., molten sodium chloride, which has a high melting point).

Herein, for clarity and without limitation, ionic liquids can include for example 1-propyl-3-methylimidazolium chloride. Many salts exist that are ionic liquids, which are usable in the methods, apparatus, and processes herein. Some further examples of ionic liquids include but are not limited to 1-allyl-3-methylimidazolium chloride, 1-butyl-3-methylimidazolium chloride, 1-ethyl-3-methylimidazolium chloride, 1-(2-hydroxylethyl)-3-methylimidazolium chloride, 1-butyl-1-methylpyrrolidinium decanoate. For clarity, additional ionic liquids may be known in the art and can be employed with the methods of the present invention.

In some embodiments, the ionic liquid comprises immidazolium-based, pyridinium-based and/or choline-based cations. In various embodiments, the ionic liquid is selected from the group consisting of 1-butyl-3-methylimidazolium chloride, 1-allyl-3-methylimidazolium chloride, 1-propyl-3-methylimidazolium chloride, 1-ethyl-3-methylimidazolium chloride, 1-(2-hydroxylethyl)-3-methylimidazolium chloride, 1-butyl-1-methylpyrrolidinium decanoate and any combination thereof.

In some embodiments, the anion component of the ionic liquid includes for example and without limitation chloride, acetate, bromide, iodide, fluoride and nitrate.

The invention also encompasses using mixtures of ionic liquids and/or adding any suitable enhancer, modifier, or the like. In some cases, the ionic liquid comprises a plurality of species of cation and/or anion. In some cases, the overall charge of an ionic liquid is neutral, but this is not required.

The invention also encompasses using materials convertible to, and/or converted to an ionic liquid. For example, some ionizable compounds can become more dissociated into ions when mixed with an ionic liquid.

The ionic liquids can be hydrophilic, meaning that they are miscible in any proportion with water. In some cases, the ionic liquids are hydrophobic. Hydrophobic ionic liquids can contain some water. Hydrophobic ionic liquids are not miscible with water and at certain concentrations, for example, form a water phase and an ionic liquid phase.

In some embodiments, the ionic liquid is a biomass dissolving ionic liquid (e.g., is capable of dissolving biomass). The solubility of biomass in the ionic liquid can be any suitable value including about 1%, about 3%, about 5%, about 10%, about 15%, about 20%, about 25%, about 30%, about 35%, about 40%, about 50%, and the like by mass. In some embodiments, the solubility can be about 1% to about 50%, about 3% to about 40%, about 5% to about 35%, about 10% to about 30%, or about 15% to about 25% by mass. In some embodiments, the solubility of biomass in the ionic liquid is at least 1%, at least 3%, at least 5%, at least 10%, at least 15%, at least 20%, at least 25%, at least 30%, at least 35%, at least 40%, at least 50%, and the like by mass.

In some embodiments, the ionic liquid is insoluble in a fluid (e.g., supercritical or near-supercritical fluid). In various embodiments, a fluid dissolves about 5%, about 1%, about 0.5%, about 0.1%, about 0.05%, about 0.01%, about 0.005%, about 0.001%, about 0.0005%, and the like ionic liquid by mass in comparison to the mass of the fluid. In some embodiments, the fluid dissolves about 0.0005 to about 5%, about 0.001% to about 1%, 0.005% to about 0.5%, or about 0.01% to about 0.1% ionic liquid by mass in comparison to the mass of the fluid. In various embodiments, a fluid dissolves at most about 5%, at most about 1%, at most about 0.5%, at most about 0.1%, at most about 0.05%, at most about 0.01%, at most about 0.005%, at most about 0.001%, at most about 0.0005%, and the like ionic liquid by mass in comparison to the mass of the fluid. In some embodiments, the fluid dissolves at most about 0.0005 to about 5%, about 0.001% to about 1%, 0.005% to about 0.5%, or about 0.01% to about 0.1% ionic liquid by mass in comparison to the mass of the fluid.

In certain embodiments, the ionic liquid is non-toxic, biodegradable, non-flammable, or has other properties that result in a safe and environmentally friendly process.

### Ionic Liquid Recovery

The methods described herein use ionic liquids efficiently. In some cases, very little of the ionic liquid is lost in the process. In some instances, the process includes recovering biomass components from the ionic liquid. Other examples of process where the ionic liquid can be used efficiently include for example without limitation manufacturing and/or purification of the ionic liquid, use of the ionic liquid in electrochemical devices such as batteries and capacitors, use of ionic liquids in chemical processes including fossil fuel processing.

In an aspect, the method for separating a biomass component from an ionic liquid comprises losing less than 10 grams of ionic liquid per kilogram of biomass component separated. In some embodiments, less than 1 gram of ionic liquid is lost per kilogram of biomass component separated. In some instances, less than 0.1 gram of ionic liquid is lost per kilogram of biomass component separated. In some instances, less than 0.01 gram of ionic liquid is lost per kilogram of biomass component separated. In some instances, less than 0.001 gram of ionic liquid is lost per kilogram of biomass component separated. In some instances, the method comprises contacting a composition comprising an ionic liquid and a biomass component with a fluid. In some embodiments, less than about 10 gram to about 0.001 gram of ionic liquid is lost per kilogram of biomass component separated. In some embodiments, less than about 1 gram to about 0.001 gram of ionic liquid is lost per kilogram of biomass component separated. In some embodiments, less than about 1 gram to about 0.01 gram of ionic liquid is lost per kilogram of biomass component separated. In some embodiments, less than about 0.1 gram to about 0.001 gram of ionic liquid is lost per kilogram of biomass component separated. In some embodiments, less than about 0.1 gram to about 0.01 gram of ionic liquid is lost per kilogram of biomass component separated.

The ionic liquid can be recovered to any suitable level. In some instances, at least 95%, at least 96%, at least 97%, at least 98%, at least 99%, at least 99.5%, at least 99.9%, at least 99.99%, at least 99.999%, at least 99.9999%, or at least 99.99999% of the ionic liquid is recovered (e.g., per batch or per week of operation). In some embodiments, the ionic liquid is recovered in a range of at least 95% to at least 99.99999%, at least 96% to at least 99.999%, at least 97% to at least 99.99%, at least 98% to at least 99.9%, or at least 99% to at least 99.5%.

The purity of the ionic liquid following the process is any suitable level. In some instances, the ionic liquid is at least 95%, at least 96%, at least 97%, at least 98%, at least 99%, at least 99.5%, at least 99.9%, at least 99.99%, at least 99.999%, at least 99.9999%, or at least 99.99999% pure. In some embodiments, the ionic liquid has a purity in a range of at least 95% to at least 99.99999%, at least 96% to at least 99.999%, at least 97% to at least 99.99%, at least 98% to at least 99.9%, or at least 99% to at least 99.5%.

In some instances, the ionic liquid is re-used after the process (e.g., after recovering biomass components from the ionic liquid).

The process using the ionic liquid can include for example and without limitation can be a batch process, a continuous process, a semi-batch process, or combination thereof.

Suitable methods for determining the amount of ionic liquid lost from the process include, but are not limited to determining the mass of ionic liquid before and after the process, or operating the process for a period of time and observing a loss in ionic liquid over that time period.

### Recovery of Concentrated Components

In some instances, recovery of solutes from ionic liquids using chromatography results in an ionic liquid that is diluted (e.g., in water). In contrast, in some embodiments, the process described herein does not dilute the ionic liquid. That is, the process (e.g., separation of biomass components from an ionic liquid) does not comprise a step of concentrating the ionic liquid (e.g., by evaporating water from the ionic liquid).

In an aspect, a method is described for separating a hydrogen bonding solute from a composition comprising an ionic liquid and a hydrogen bonding solute, wherein the concentration of the ionic liquid decreases by less than 100%, less than 50%, less than 20%, less than 10%, or less than 5% when the hydrogen bonding solute is separated from the composition. In some embodiments, the concentration of the ionic liquid decrease less than 5% to less than 100%, less than 10% to less than 50%, or less than 20% to less than 50% when the hydrogen bonding solute is separated from the composition. In some embodiments, the concentration of the ionic liquid in the composition is decreased by the addition of a solvent (e.g., water, ethanol) to the composition when the hydrogen bonding solute is recovered from the ionic liquid. The amount of solvent added to the composition is low in some cases.

In an aspect, a method is described for separating a hydrogen bonding solute from a composition comprising an ionic liquid and a hydrogen bonding solute, wherein the concentration of the ionic liquid increases when the hydrogen bonding solute is separated from the composition. In some cases, water is separated from the composition along with the hydrogen bonding solute. The concentration of the ionic liquid can increase by any suitable percentage. In some instances, the concentration of the ionic liquid is increased by at least 1%, at least 3%, at least 5%, at least 10%, at least 20%, at least 30%, at least 50%, or at least 70%.

In some cases, chromatography dilutes the solute when recovered from the ionic liquid (i.e., the concentration of the solute in the ionic liquid is greater than the concentration of the solute when recovered). In contrast, in some embodiments, the process described herein results in a concentrated solute.

In an aspect, a method is described for separating water and a hydrogen bonding solute from a composition comprising an ionic liquid, water and hydrogen bonding solute, wherein the ratio of the mass of water to the mass of hydrogen bonding solute when separated is approximately equal to the ratio of the mass of water to the mass of hydrogen bonding solute in the composition.

For example, the composition can contain 80% ionic liquid, 10% water and 10% hydrogen bonding solute. Here, the ratio of the mass of water to the mass of hydrogen bonding solute in the composition is 1.0. If, for example, a separated composition comprising 50% water and 50% hydrogen bonding solute is separated from the ionic liquid, the ratio of 1.0 is preserved. In this example, the ratio (of 1.0) is equal.

In some embodiments, the ratio of the mass of water to the mass of hydrogen bonding solute when separated is within about 5%, within about 10%, within about 20%, within about 30%, or within about 50% of the ratio of the mass of water to the mass of hydrogen bonding solute in the composition. In some embodiments, the mass of hydrogen bonding solute when separated is within about 5% to about 50%, about 10% to about 50%. about 20% to about 50%, or about 20% to about 30% of the ratio of the mass of water to the mass of hydrogen bonding solute in the composition.

In some cases, the hydrogen bonding solute is recovered from the ionic liquid in a concentrated solution. They recovered hydrogen bonding solute does not require any concentration steps (e.g., evaporation or distillation) in some instances.

In an aspect, a method is described for separating water and hydrogen bonding solute from a composition comprising an ionic liquid, water and hydrogen bonding solute, wherein the hydrogen bonding solute is separated from the ionic liquid at a concentration of at least 5%, at least 10%, at least 20%, at least 30%, at least 40%, at least 50%, at least 60%, at least 70%, or at least 80% (w/w). In some embodiments, the hydrogen bonding solute is separated from the ionic liquid at a concentration of at least 5% to at least 80%, at least 10% to at least 70%, at least 20% to at least 60%, at least 30% to at least 50%, or least 40% to at least 50%.

In some embodiments, the hydrogen bonding solute is derived from biomass. A hydrogen bonding solute is any molecule capable of forming one or more hydrogen bonds. In some cases, the hydrogen bonding solute is capable of forming one or more hydrogen bonds with an ionic liquid and/or water. The hydrogen bonding solute can have at least one hydroxyl group. In various embodiments, the hydrogen bonding solute can be a carbohydrate, a sugar, an aldose, a ketose, or any combination thereof. In some cases, the hydrogen bonding solute is derived from biomass. In some cases, the hydrogen bonding solute is a carbohydrate (e.g., glucose, xylose, mannose, or galactose). In some cases, the hydrogen bonding solute is an alcohol (e.g., ethanol or methanol).

In some instances, the composition comprises the ionic liquid and a furanic compound and the furanic compound is separated from the ionic liquid at a concentration of at least 10% (w/w).

### Reduction of Dielectric Constant

Ionic liquids can have a high ionic strength and/or high dielectric constant. The dielectric constant (also referred to as static relative permittivity) is the ratio of the amount of electrical energy stored in a material by an applied voltage, relative to that stored in a vacuum. Dielectric constant is generally represented by the Greek letter epsilon and has no units (i.e., is a dimensionless number).

Some solutes dissolve in ionic liquids having a certain dielectric constant. In an aspect, described herein is a method for separating a solute from an ionic liquid comprising reducing the dielectric constant of a composition comprising an ionic liquid and a solute. In some cases, the dielectric constant is reduced by contacting the composition with a pressurized gas. In some embodiments, the composition is not mixed with a liquid (e.g., water). In some embodiments, the dielectric constant of the ionic liquid is increased following separation of the solute by de-pressurizing the gas and/or separating the gas from the composition. The ionic liquid can be recycled and/or re-used.

The dielectric constant can be reduced by any suitable amount. In some embodiments, the dielectric constant is reduced by about 0.1%, about 0.5%, about 1%, about 2%, about 3%, about 5%, about 10%, about 15%, about 20%, about 25%, about 30%, about 40%, about 50%, about 60%, about 70%, about 80%, about 90%, about 95%, or about 99%. In some embodiments, the dielectric constant is reduced by at least 0.1%, at least 0.5%, at least 1%, at least 2%, at least 3%, at least 5%, at least 10%, at least 15%, at least 20%, at least 25%, at least 30%, at least 40%, at least 50%, at least 60%, at least 70%, at least 80%, at least 90%, at least 95%, or at least 99%. In some embodiments, the dielectric constant is reduced by at least about 0.1% to about 99%, about 0.5% to about 95%, about 1% to about 90%, about 2% to about 80%, about 3% to about 70%, about 5% to about 60%, or about 10% to about 70%.

The dielectric constant can be reduced to any suitable value. In some embodiments, the dielectric constant is reduced to an epsilon of about 2, about 4, about 6, about 8, about 10, about 12, about 14, about 16, about 18, about 20, about 25, about 30, about 40, about 50, or about 100. In some embodiments, the dielectric constant is reduced to an epsilon of less than 2, less than 4, less than 6, less than 8, less than 10, less than 12, less than 14, less than 16, less than 18, less than 20, less than 25, less than 30, less than 40, less than 50, or less than 100.

In some embodiments, the solute is precipitated from the ionic liquid. In some cases, the solute comprises sugar and/or a furanic compound. In some cases, the solute comprises lignin, ash and/or protein.

### Biomass

In some embodiments, the invention provides methods for separating biomass and/or biomass components from ionic liquids. The biomass can be any suitable material, including mixed material or materials that can change or are changed over time. In some embodiments, the present invention may be practiced in a feedstock-flexible biorefinery.

The biomass can include for example and without limitation plant matter, algae, seaweed, agricultural or forestry residue, industrial or municipal waste, or any other suitable material. As used herein, “biomass” includes any component of the biomass (e.g., lipids, proteins, cellulose, lignin) and/or derivatives of the plant material and/or derivatives of its components (e.g., cellulose hydrolyzed to sugars, sugars dehydrated to furanic compounds).

The biomass can be purposely grown for processing as described herein, or the biomass can grow and/or be grown for any purpose and be processed in whole or in part using the methods described herein. The biomass can be farmed (including both food crops and energy crops) or grow wild. The biomass can be for example genetically modified, wild type, and/or selectively bred in various embodiments.

In some instances the biomass is cellulosic, meaning that it comprises cellulose or derivatives thereof. Cellulose is a polymer of glucose monomers (e.g., beta 1-4 linked, a polysaccharide). In some instances, the cellulose is broken down and/or hydrolyzed (e.g., to sugars).

In some instances, the biomass is lignocellulosic, meaning that it comprises cellulose and lignin. Lignin is a complex chemical compound that forms part of some plants (e.g., cell walls). Lignin is generally heterogeneous and lacks of a defined primary structure. Lignin can comprise biopolymers of p-coumaryl alcohol, coniferyl alcohol and/or sinapyl alcohol. In some instances, the biomass has no lignin or a small amount of lignin (e.g., less than 5%, less than 3%, or less than 1%).

Cellulosic and/or lignocellulosic biomass may also comprise hemicellulose. A hemicellulose is any of several heteropolymers, such as arabinoxylans, present along with cellulose in some plant cell walls. Hemicellulose may contain many different sugar building blocks. In contrast, cellulose generally contains only anhydrous glucose. For instance, besides glucose, sugar building blocks in hemicellulose can include xylose, mannosc, galactose, rhamnosc, and arabinosc. Hemicelluloses may contain pentose (5 carbon) sugars. In some instances, xylose is the sugar monomer present in the largest amount, but mannuronic acid and galacturonic acid may also be present among others. In some instances, hemicellulose is broken down and/or hydrolyzed into sugars.

The biomass may be an energy plant and/or energy crop. Exemplary energy crops include without limitation farmed trees such as Pinus radiata, and fast growing plants such as Miscanthus giganteus and Panicum virgatum. Energy cane, sorghum, sweet sorghum are further examples of energy crops. Energy crops can comprise lignocellulose and sometimes require less water, fertilizer, and the like to grow rapidly compared with a food crop. In some cases, energy crops are grown on land unsuitable for growing food crops. The biomass may also be all or part of a plant that is more traditionally a food crop, such as corn (Zea mays) or sugar cane.

In some embodiments, the biomass is algae, which includes but is not limited to eukaryotic microalgae, cyanobacteria, diatoms, macroalgae, and the like. Algae are generally photosynthetic, but lack roots, leaves and other structures found in plants. Some algae live in aqueous rather than terrestrial environments. Algae are distinct from plants. Exemplary algae species include, but are not limited to Chlamydomonas moewusii, Chlamydomonas reinhardii, Neochloris pseudostigmata, Scenedesmus quadricauda, Chlorella vulgaris, Chlorococcum hypnosporum, Dunaliella salina, Chlorella pyrenoidosa.

In some embodiments, the algae may be processed using the methods described herein in a substantially aqueous form. That is, it is drying and/or dewatering the algae may be unnecessary, which may reduce the amount of energy needed to grow algae and isolate useful materials therefrom. In various embodiments, the algae may comprise at least 95% water, at least 90% water, at least 80% water, at least 70% water, at least 60% water, at least 50% water, at least 30% water and the like.

In some embodiments, the biomass is a mixture of algae and lignocellulose. In some embodiments, water is added to the ionic liquid. In some embodiments, the water can comprise algae biomass (or any other biomass) wherein algae and lignocellulose are co-processed.

### Biomass Components and Derivatives

In some instances, biomass components are removed from ionic liquids. The biomass can optionally be broken down into its components in the ionic liquid, or may be broken down by other means and added to an ionic liquid. In some instances, the biomass components are not only removed from the ionic liquid, but also fractionated. For instance, carbohydrates can be fractionated from lipids and/or proteins (e.g., biomass components arc isolated from each other). In some embodiments, various sugars may be isolated from each other, such as for example glucose from other sugars such as arabinose and xylose.

Exemplary biomass components include, but are not limited to nucleic acids, proteins, lipids, fatty acids, resin acids, waxes, terpenes, acetates (e.g., ethyl acetate, methyl acetate), carbohydrates, polysaccharides cellulose, hemicellulose, alcohols, sugars, sugar acids, glucose, fructose, xylose, galactose, arabinose, mannose, rhamnose, mannuronic acid, galacturonic acid, lignin, alcohols (e.g., methanol, ethanol), phenols, aldehydes, ethers, p-coumaryl alcohol, coniferyl alcohol, sinapyl alcohol, pectin, D-galacturonic acid, amino acids, acetic acid, ash, any derivative thereof (e.g., furanic compounds), or any combination thereof. Any suitable biomass component can be recovered from ionic liquids as described herein.

In some embodiments, the biomass components include carbohydrates. Carbohydrates have the chemical formula Cₘ(H₂O)ₙ, where m and n are integers. In some cases, the biomass component is a carbohydrate derivative (e.g., chloroglucose (C₆H₁₁O₅Cl)). Carbohydrates include water-soluble carbohydrates and water-insoluble carbohydrates.

Polysaccharides are also biomass components (e.g., cellulose, starch, or hemicellulose). In various embodiments, the biomass may comprise polysaccharides of any average degree of polymerization and/or profile or range of degrees of polymerization. In some instances, cellulose may have 7,000-15,000 glucose molecules per polymer and hemicellulose may have about 500-3,000 sugar units. In some examples, the degree of polymerization of the polysaccharide is reduced in the ionic liquid. In some embodiments, polysaccharides that have a degree of polymerization of at most about 20, at most about 5, at most 2, or at most one (i.e., monosaccharides) are recovered from the ionic liquid as described herein. In some embodiments, the polysaccharides recovered are water-soluble and/or fermentable. In some cases, the recovered polysaccharides comprise between 1 and about 2, about 3, about 4, about 5, about 6, about 7, about 8, about 9 or about 10 sugar units. In some embodiments, low molecular weight carbohydrates (e.g., polysaccharides) are continuously removed from the ionic liquid reaction as the polysaccharides are continuously broken down to lower molecular weight carbohydrates (e.g., sugars).

In some embodiments, the biomass components include sugars. Sugars include monosaccharides, disaccharides and oligosaccharides.

In some instances, the sugars are fermentable. Fermentable sugars are capable of nourishing and/or sustaining a culture of microbes (e.g., E. coli and/or yeast). Various microorganisms are capable of using various sugars, so while arabinosc may be fermentable by one organism it may not be by another. For the purposes of clarity, a sugar is fermentable if there is at least one microorganism known to be capable of growing on the sugar and/or metabolizing the sugar. Exemplary fermentable sugars include but are not limited to glucose, fructose, xylose, or combinations thereof. Fermentable sugars need not be monosaccharides.

As used herein, biomass includes derivatives of biomass and/or derivatives of biomass components. Also, as used herein, biomass components includes derivatives of biomass components. In some cases, at least some of the mass of the derivative (e.g., at least some atoms) are traceable back to biomass and/or biomass component (e.g., plant material and/or cellulose). For example, furanic compounds (e.g., hydroxymethylfurfural, 2,5-dimethylfuran) can be produced by the dehydration of sugars, so are an example of a biomass derivative. A method for producing furanic compounds from biomass is described for example in U.S. Patent Pub. No. 2010/0004437, which is herein incorporated by reference in its entirety. Those of ordinary skill in the art will be aware of many biomass derivatives including polyols, and the like.

### Biomass Hydrolysis

In some embodiments, the biomass is hydrolyzed. Hydrolysis includes cleavage of glycosidic bonds between sugar building blocks in a polysaccharide (e.g., cellulose, hemicellulose, starch). Hydrolysate is biomass that has at least partially undergone a hydrolysis reaction. In hydrolysate, the average degree of polymerization of the polysaccharides comprising the biomass can be reduced. The biomass need not be hydrolyzed to monomeric sugars. Biomass can be hydrolyzed to any suitable extent. In some embodiments, about 5%, about 10%, about 20%, about 30%, about 40%, about 50%, about 60%, about 70%, about 80%, about 90%, about 95%, about 96%, about 97%, about 98%, about 99%, about 99.5% or about 99.9% of the glycosidic bonds are hydrolyzed. In some embodiments, at least 5%, at least 10%, at least 20%, at least 30%, at least 40%, at least 50%, at least 60%, at least 70%, at least 80%, at least 90%, at least 95%, at least 96%, at least 97%, at least 98%, at least 99%, at least 99.5% or at least 99.9% of the glycosidic bonds are hydrolyzed.

In some cases, the biomass is provided in hydrolyzed form. In some instances, the biomass is hydrolyzed in an ionic liquid and the hydrolysate or components thereof is recovered from the ionic liquid. Biomass can be hydrolyzed using any suitable method (e.g., by acids, by enzymes, in ionic liquids). In some cases, the biomass is hydrolyzed according to the methods described for example in U.S. Patent Pub. No. 2011/0065159, which is herein incorporated by reference in its entirety.

In some embodiments, the biomass is at least partially dissolved in the ionic liquid. In some cases, the reaction mixture comprises some non-dissolved biomass (including components of biomass such as lignin). In some instances, solubilization and hydrolysis of the biomass occurs simultaneously in the ionic liquid. The ionic liquid can contain a catalyst. The catalyst can catalyze hydrolysis in some cases (e.g., acid). In some embodiments, the catalyst increases the rate of production of furanic compounds.

In some embodiments, the ionic liquid further comprises an acid (e.g., hydrochloric acid, sulfuric acid, carbonic acid, sulfuric acid, nitric acid, phosphoric acid, maleic acid). In some embodiments, the acid is immobilized (e.g., onto a surface such as silicon oxide particles). In some cases, the ionic liquid is acidic (e.g., the ionic liquid comprises an acidic functionality and/or is acid-functionalized). Examples of acidic ionic liquids include, but are not limited to 1-butyl-3-methylimidazolium bisulfate (C4mimHSO₄) and 1-(4-sulfobutyl)-3-methylimidazolium bisulfate (SbmimHSO₄).

In some cases, the rate and/or timing of water addition to a hydrolysis reaction is such that the yield and/or rate of hydrolysis is high (e.g., a yield of at least 40%, at least 50%, at least 60%, at least 70%, at least 80%, at least 90%, at least 95%, or at least 99%, wherein the yield is achieved in less than 5 minutes, less than 10 minutes, less than 30 minutes, less than 1 hour, less than 3 hours, less than 5 hours, or less than 9 hours). In some embodiments, the rate and/or timing of water addition provides water as a reactant in hydrolysis, while maintaining a high solubility of biomass in the ionic liquid (e.g., at least 50%, at least 60%, at least 70%, at least 80%, at least 90%, at least 95% or at least 99% of the solubility when no water is present).

In an aspect, provided herein is a method for hydrolyzing biomass, the method comprising adding water to a reaction mixture comprising ionic liquid and biomass, wherein the water is added at a rate such that the solubility of the biomass is not substantially inhibited (e.g., at least 50%, at least 60%, at least 70%, at least 80%, at least 90%, at least 95% or at least 99% of the solubility when no water is present) and hydrolysis is not substantially inhibited (e.g., at least 50%, at least 60%, at least 70%, at least 80%, at least 90%, at least 95% or at least 99% of the maximum hydrolysis rate).

In another aspect, provided herein is a method for hydrolyzing biomass, the method comprising adding water to a reaction mixture comprising ionic liquid and biomass, wherein the water is added at a rate such that the rate of biomass solubilization is not substantially inhibited (e.g., at least 50%, at least 60%, at least 70%, at least 80%, at least 90%, at least 95% or at least 99% of the rate of solubilization when no water is present) and hydrolysis is not substantially inhibited (e.g., at least 50%, at least 60%, at least 70%, at least 80%, at least 90%, at least 95% or at least 99% of the maximum hydrolysis rate).

In another aspect, provided herein is a method for hydrolyzing biomass, the method comprising adding water to a reaction mixture comprising ionic liquid and biomass, wherein the water is added at a rate that is approximately equal to the rate at which water is consumed in the reaction (e.g., the water addition and consumption rates are no more than about 1%, about 3%, about 5%, about 10%, about 20%, or about 50% different).

In another aspect, provided herein is a method for hydrolyzing biomass, the method comprising adding water to a reaction mixture comprising ionic liquid and biomass, wherein the water is added at a rate that maintains the water concentration in the reaction mixture below about 45%, below about 35%, below about 25%, below about 15%, below about 10%, below about 5%, below about 3%, or below about 1% (w/w). In some embodiments, the water concentration in the reaction mixture is maintained between 0% and about 5%, or between 0% and about 10%.

In another aspect, provided herein is a method for hydrolyzing biomass, the method comprising adding water to a reaction mixture comprising ionic liquid and biomass, wherein the temperature of the mixture is such that the yield of sugars is at least 2 times, at least 5 times, at least 10 times, at least 20 times, at least 50 times, at least 100 times, or at least 1000 times greater than the yield of furanic compounds.

### Fluids Including Pressurized Gases and Supercritical Fluids

In some instances, the methods described herein use fluids. Exemplary fluids include but are not limited to gases, liquids, pressurized gases, liquefied gases, sub-critical fluids, volatile liquids, and/or supercritical or near-supercritical fluids. For example, in one embodiment, a composition comprising an ionic liquid, water and a hydrogen bonding solute is contacted with a gas to form a first phase comprising an ionic liquid and a second phase comprising water and a hydrogen bonding solute. In another embodiment, a composition comprising a furanic compound and an ionic liquid is contacted with a pressurized gas. In yet another embodiment, a composition comprising one or more biomass components in an ionic liquid is contacted with a supercritical or near-supercritical fluid.

In some embodiments, the fluid is selected from the group consisting of CO₂, NO₂, NH₃, water, acetic acid, methanol, ethanol, n-butane, nitrogen, hydrogen, helium, argon, oxygen, methane, ethane, propane, ethylene, propylene, and combinations thereof. In some embodiments, the fluid is CO₂.

For clarity, “contacted with a gas” does not necessarily mean that the fluid is a gas when contacted with the ionic liquid. In some cases, the gas can be pressurized such that it is a dense phase (e.g., liquefied gas or supercritical fluid) when contacted. As used herein, a gas is a material that is a vapor at International Union of Pure and Applied Chemistry (IUPAC) standard temperature and pressure (0° C. and 1 bar). A pressurized gas is any gas at a pressure greater than 1 bar.

In some embodiments, the ionic liquid is contacted with a pressurized gas. In some instances, the gas is pressurized to an absolute pressure greater than atmospheric pressure. In some embodiments, the pressure is about 1 bar, about 2 bar, about 5 bar, about 10 bar, about 20 bar, about 30 bar, about 40 bar, about 50 bar, about 100 bar, about 200 bar, about 300 bar or about 400 bar. In some embodiments, the pressure is at least 1 bar, at least 2 bar, at least 5 bar, at least 10 bar, at least 20 bar, at least 30 bar, at least 40 bar, at least 50 bar, at least 100 bar, at least 200 bar, at least 300 bar or at least 400 bar.

In some embodiments, the ionic liquid is contacted with a liquefied gas. Examples of gases that can be liquefied include propane, hydrogen, nitrogen, n-butane and carbon dioxide.

In some embodiments, the ionic liquid is contacted with a volatile liquid. Examples of liquids that are readily volatile include propanone, methanol and ethanol.

The critical temperature of a fluid is the temperature above which a distinct liquid phase does not exist (e.g., regardless of pressure). The vapor pressure of a fluid at its critical temperature is its critical pressure. At temperatures and pressures above its critical temperature and pressure (e.g., its critical point), a fluid is called a supercritical fluid. Many fluids can form supercritical fluids provided they do not degrade or decompose at temperatures below their critical temperature.

In some instances, the methods of the present invention can use any suitable supercritical or near-supercritical fluid. Information on supercritical fluids can be found in “Fundamentals of Supercritical Fluids” by Tony Clifford (ISBN: 978-0198501374), “Supercritical Carbon Dioxide: Separations and Processes” by Aravamudan S. Gopalan (ISBN: 978-0841238367), and “Supercritical Fluid Extraction” by Larry T. Taylor (ISBN: 978-0471119906), each of which is herein incorporated by reference in its entirety.

The fluid can be supercritical, in that both the temperature is at or above its critical temperature and the pressure is at or above its critical pressure. In some embodiments, the pressure is about 100%, about 120%, about 150%, about 200%, about 300%, about 500%, and the like of the fluid's critical pressure. In some embodiments, the pressure is at least about 100%, at least about 120%, at least about 150%, at least about 200%, at least about 300%, at least about 500%, and the like of the fluid's critical pressure. In some embodiments, the temperature is about 100%, about 120%, about 150%, about 200%, about 300%, about 500%, and the like of the fluid's critical temperature. In some embodiments, the temperature is at least about 100%, at least about 120%, at least about 150%, at least about 200%, at least about 300%, at least about 500%, and the like of the fluid's critical temperature. In some embodiments, the pressure is between about 80% and 400% of the fluid's critical pressure. In some embodiments, the temperature is between about 80% and 400% of the fluid's critical temperature.

The fluid can be sub-critical (e.g., near-supercritical), in that one or both of the temperature is below the fluid's critical temperature and the pressure is below its critical pressure. A near-supercritical fluid may have properties similar or near the properties of a supercritical fluid. In various embodiments, the pressure is about 99%, about 98%, about 95%, about 90%, about 85%, about 75%, about 50%, about 20%, and the like of the fluid's critical pressure. In various embodiments, the pressure is at least about 99%, at least about 98%, at least about 95%, at least about 90%, at least about 85%, at least about 75%, at least about 50%, at least about 20%, and the like of the fluid's critical pressure. In various embodiments, the temperature is about 99%, about 98%, about 95%, about 90%, about 85%, about 75%, about 50%, about 20%, and the like of the fluid's critical temperature. In various embodiments, the temperature is at least about 99%, at least about 98%, at least about 95%, at least about 90%, at least about 85%, at least about 75%, at least about 50%, at least about 20%, and the like of the fluid's critical temperature.

In some embodiments, fluids with low critical temperatures and/or pressures may be employed (e.g., to reduce the amount of energy that needs to be put into the process to heat and/or pressurize the fluid). In some embodiments, fluids with low temperatures are employed (e.g., to preserve heat labile reactants and/or products). In some embodiments, the temperature is sufficiently low to avoid decomposition of the biomass components (e.g., less than 200° C., less than 150° C., less than 100° C., less than 80° C., less than 60° C., less than 40° C., less than 30° C., less than 20° C., or less than 10° C.).

Supercritical fluids can have densities, viscosities, and other properties that are intermediate between those of the fluid in its gaseous and in its liquid state. Table 1 lists some supercritical properties of four compounds. These four fluids are examples of fluids that have relatively moderate critical temperatures (e.g., less than 200° C., less than 150° C., less than 100° C., less than 80° C., less than 60° C., less than 40° C., less than 30° C., less than 20° C., or less than 10° C.) and critical pressures (e.g., less than 200 atm, less than 150 atm, less than 120 atm, less than 110 atm, less than 100 atm, less than 90 atm, less than 80 atm, less than 70 atm, less than 60 atm, less than 50 atm, less than 40 atm, less than 30 atm, or less than 20 atm).

TABLE 1
Supercritical properties of exemplary fluids

| | Critical | Critical | Critical Point | Density |
|---|---|---|---|---|
| | Temperature, | Pressure, | Density, | at 400 |
| Fluid | ° C. | atm | g/mL | atm, g/mL |
| CO₂ | 13.2 | 72.9 | 0.47 | 0.96 |
| N₂O | 36.5 | 71.7 | 0.45 | 0.94 |
| NH₃ | 132.5 | 112.5 | 0.24 | 0.40 |
| n-Butane | 152.0 | 37.5 | 0.23 | 0.50 |

In some cases, supercritical fluids dissolve solutes in proportion to the density of the fluid. In some embodiments, the supercritical or near-supercritical fluid has a density of about 0.05, about 0.1, about 0.15, about 0.2, about 0.25, about 0.3, about 0.35, about 0.4, about 0.5, about 0.6, about 0.7, about 0.8, about 0.9, or about 1.0 g/mL. In some embodiments, the supercritical or near-supercritical fluid has a density of at least 0.05, at least 0.1, at least 0.15, at least 0.2, at least 0.25, at least 0.3, at least 0.35, at least 0.4, at least 0.5, at least 0.6, at least 0.7, at least 0.8, at least 0.9, or at least 1.0 g/mL. In some embodiments, the supercritical or near-supercritical fluid has a density of between about 0.2 and 0.9 g/mL.

In various embodiments, the supercritical or near-supercritical fluid is capable of extracting solutes having a molecular weight of about 100, about 200, about 300, about 400, about 500, about 600, about 800, about 1000, about 1200, about 1500, about 2000, or about 3000 atomic mass units (amu). In some embodiments, the supercritical or near-supercritical fluid is capable of extracting solutes having a molecular weight of less than 100, less than 200, less than 300, less than 400, less than 500, less than 600, less than 800, less than 1000, less than 1200, less than 1500, less than 2000, or less than 3000 atomic mass units (amu). In some embodiments, the supercritical or near-supercritical fluid is capable of extracting solutes having a molecular weight of greater than 100, greater than 200, greater than 300, greater than 400, greater than 500, greater than 600, greater than 800, greater than 1000, greater than 1200, greater than 1500, greater than 2000, or greater than 3000 atomic mass units (amu). In some embodiments, the supercritical or near-supercritical fluid is capable of extracting solutes having a molecular weight of between about 10 and 600 amu. Solutes can include for example but are not limited to biomass components.

In some embodiments, the supercritical or near-supercritical fluid is selected from the group consisting of CO₂, NO₂, NH₃, water, acetic acid, methanol, ethanol, n-butane, nitrogen, hydrogen, helium, argon, oxygen, methane, ethane, propane, ethylene, propylene, and combinations thereof. In some embodiments, the supercritical or near-supercritical fluid is CO₂.

In some embodiments, the fluid is substantially pure (e.g., at least 80%, 90%, 95%, 99%, 99.5, or 99.9% pure). In some embodiments, the fluid is a mixture.

In one embodiment, the supercritical or near-supercritical fluid is CO₂ comprising water. In some instances, water increases the solubility of sugars in CO₂. Without being held to any particular theory, it is thought that polar and/or hydrogen bonding interactions between a polar co-solvent such as water and the sugar increases the solubility of sugars in the supercritical or near-supercritical CO₂ phase.

In certain embodiments, the fluid is non-toxic, biodegradable, non-flammable, or has other properties that result in a safe and environmentally friendly process.

### Fluid Extraction

In an aspect, described herein is a method for extracting one or more biomass components comprising contacting a solution comprising one or more biomass components in an ionic liquid with a fluid, wherein at least some of the biomass components dissolve in the fluid and/or become un-dissolved in the ionic liquid solution.

In some cases, the fluid is miscible in the ionic liquid (e.g., to any small or large extent). In some embodiments, substantially none of the ionic liquid dissolves in the fluid. For example, in some cases, the concentration of the ionic liquid in the fluid is about 1%, about 0.5%, about 0.1%, about 0.05%, about 0.01%, about 0.005%, about 0.001%, about 0.0005%, or about 0.0001% by mass (w/w). In some cases, the concentration of the ionic liquid in the fluid is less than 1%, less than 0.5%, less than 0.1%, less than 0.05%, less than 0.01%, less than 0.005%, less than 0.001%, less than 0.0005%, or less than 0.0001% by mass (w/w).

In some embodiments, some ionic liquid dissolves in the fluid at the conditions at which the ionic liquid and the fluid are contacted. When an appreciable and/or unsuitably high amount (e.g., greater than 1%, or greater than 0.1%) of ionic liquid dissolves in the fluid, the method further comprises adjusting the pressure and/or temperature so that substantially none of the ionic liquid dissolves in the fluid. In some embodiments, the pressure and/or temperature of the fluid is adjusted such that the concentration of ionic liquid in the fluid is about 1%, about 0.5%, about 0.1%, about 0.05%, about 0.01%, about 0.005%, about 0.001%, about 0.0005%, or about 0.0001% by mass (w/w). In some embodiments, the pressure and/or temperature of the fluid is adjusted such that the concentration of ionic liquid in the fluid is less than 1%, less than 0.5%, less than 0.1%, less than 0.05%, less than 0.01%, less than 0.005%, less than 0.001%, less than 0.0005%, or less than 0.0001% by mass (w/w). In some cases, the pressure is increased above the critical point of the fluid. In some cases, the temperature is increased above the critical point of the fluid.

In some embodiments, the fluid is a supercritical or near-supercritical fluid. The fluid may comprise carbon dioxide, optionally with a co-solvent such as water. The biomass components can include, but are not limited to carbohydrates (e.g., sugars), proteins, lipids, lignin, biomolecules or derivatives thereof. In some embodiments, the concentration of the sugar in the ionic liquid is at least 5%, at least 1%, at least 0.5%, or at least 0.1% by mass (w/w). In some embodiments, the concentration of the sugar in the ionic liquid is between 2% and about 15%.

### Fluid Phases

In an aspect, described herein is a composition comprising an ionic liquid, a pressurized gas, water and a biomass. In some methods, the biomass (and/or components and/or derivatives thereof) is extracted from the composition. The composition can be separated into two or more phases in some instances.

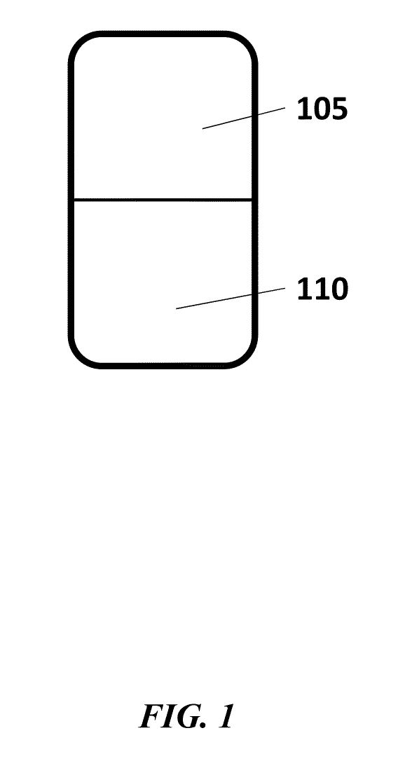

In an aspect, described herein is a multi-phasic system. With reference to FIG. 1, a first phase 105 comprises a pressurized gas, water and one or more biomass components and a second phase 110 comprises an ionic liquid and one or more biomass components. In some cases, the pressurized gas is a supercritical or near-supercritical fluid. In some instances, the first phase comprises less than 0.5%, less than 0.1%, less than 0.05%, less than 0.01%, or less than 0.005% ionic liquid by mass. The second phase may comprise at least 50% ionic liquid.

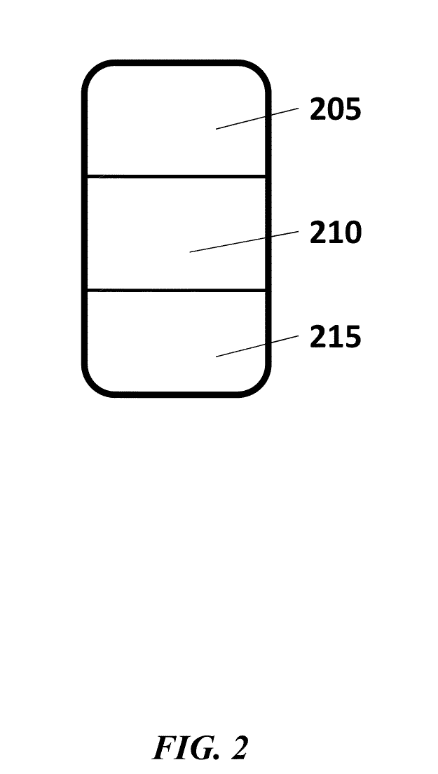

In another aspect, a multi-phasic system comprises at least three phases. With reference to FIG. 2, a first phase 205 comprises a pressurized gas, water and one or more biomass components, a second phase 210 comprises a pressurized gas, water, one or more biomass components and an ionic liquid, and a third phase 215 comprises an ionic liquid and one or more biomass components. In some instances, the first phase comprises less than 0.5%, less than 0.1%, less than 0.05%, less than 0.01%, or less than 0.005% ionic liquid by mass. The second phase may comprise at least 50% water. The third phase may comprise at least 50% ionic liquid.

### Supercritical Fluid Extraction

In an aspect, described herein is a method for extracting one or more biomass components comprising contacting a composition comprising one or more biomass components in an ionic liquid with a supercritical or near-supercritical fluid.

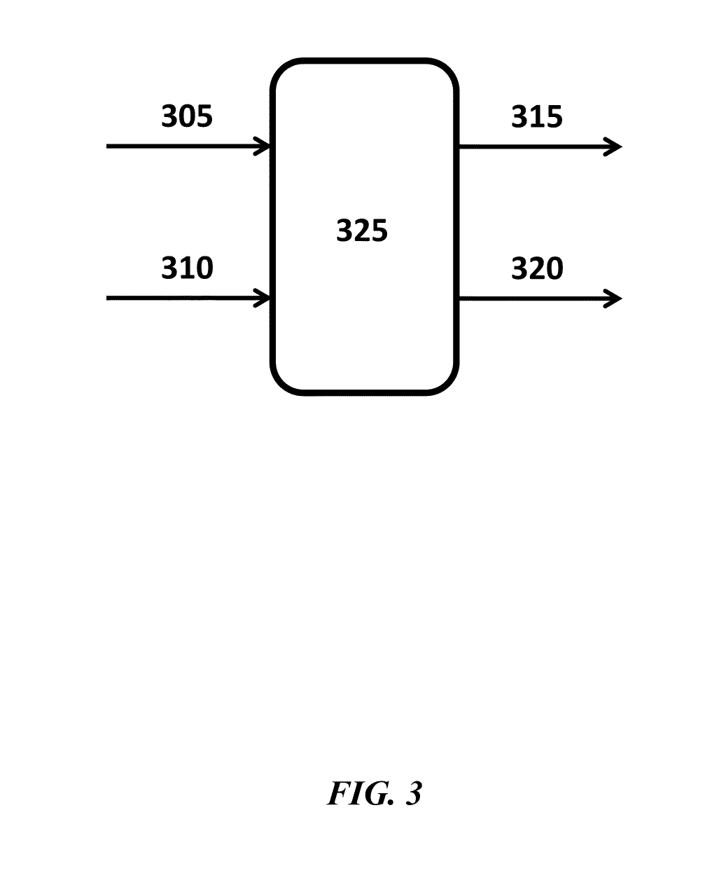

With reference to FIG. 3, a method for extracting a biomass component from an ionic liquid mixture can comprise contacting an ionic liquid mixture containing a biomass component 305 with a supercritical fluid 310 to form a post-extraction supercritical fluid mixture 315 and a post-extraction ionic liquid mixture 320. In some embodiments, the post-extraction ionic liquid mixture has less amount of the biomass component than the amount contained in the ionic liquid mixture and the post-extraction supercritical fluid mixture has more amount of the biomass component than the amount contained in the supercritical fluid. The extraction can be performed in any suitable vessel 325. In some cases, the vessel is appropriately shaped and sized to allow for adequate contacting of the ionic liquid mixture and the supercritical fluid and/or to allow for adequate partitioning of the post-extraction supercritical fluid mixture from the post-extraction ionic liquid mixture. Design of extraction vessels is generally known in the art.

In some embodiments, the post-extraction supercritical fluid mixture has a pressure such that ionic liquid is rejected from the post-extraction supercritical fluid mixture (e.g., has less than 0.5%, less than 0.1%, less than 0.05%, less than 0.01%, or less than 0.005% ionic liquid by mass).

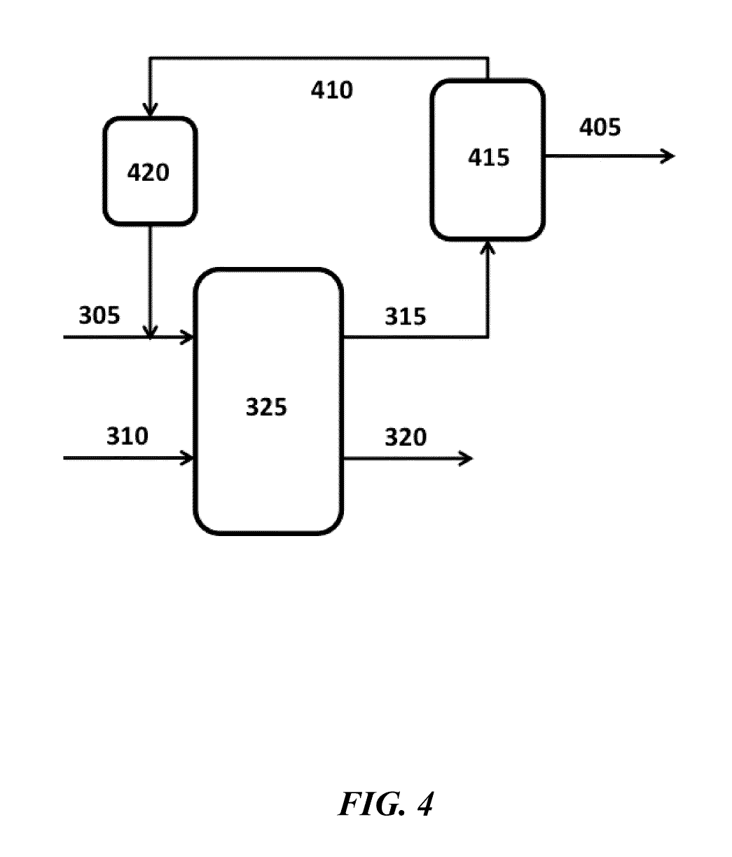

In some instances, the method further comprises recovering the extracted one or more biomass components from the supercritical or near-supercritical fluid. With reference to FIG. 4 where like numerals indicate like elements, the one or more biomass components 405 are recovered from the supercritical or near-supercritical fluid (post-extraction supercritical fluid mixture) 315. In some embodiments, following recovery of the one or more biomass components, the fluid is recycled and/or re-used 410.

The one or more biomass components can be recovered in any suitable way and/or in any suitable vessel 415. In some embodiments, the one or more biomass components are recovered from the supercritical or near-supercritical fluid by lowering the pressure of the fluid.

The pressure can be lowered to any level (e.g., to a level such that the biomass components are recovered from the fluid). Following recovery of the biomass components, the fluid can be re-pressurized and used again 410. The fluid can be re-pressurized in any suitable apparatus 420 including a compressor, a pump, or any combination thereof. In some cases, pressurization using a pump consumes less energy than pressurization using a compressor. The pressure of fluids above their critical point can be increased with a pump. In some cases, the pressure of the fluid is not lowered below the critical pressure of the supercritical or near-supercritical fluid. In some embodiments, the pressure is not lowered more than 5%, more than 10%, or more than 20% below the critical pressure of the supercritical or near-supercritical fluid.

The pressure of the fluid can be lowered at any rate. In some embodiments, the pressure of the fluid is lowered in stages where various biomass components are recovered from the fluid at various pressure stages. For example, larger molecules can be fractionated from smaller molecules by lowering the pressure in stages. In some cases, various biomass components can be fractionated from each other. Groups of molecules can be fractionated from each other such as 5 carbon sugars from 6 carbon sugars or oils from sugars. In some cases, molecular species are fractionated from each other such as glucose from xylose. Biomass components can be fractionated based on the conditions at which they are recovered from the fluid. In some cases, biomass components are fractionated based on miscibility (e.g., oil from an aqueous solution comprising sugars).

In some cases, the one or more biomass components are recovered from the supercritical or near-supercritical fluid using supercritical chromatography. In some embodiments, the vessel 415 is a supercritical chromatograph. Decreasing the pressure in the supercritical chromatograph 415 may cause various dissolved biomass components to become insoluble in the fluid at various pressures, resulting in separation of the biomass components. Separation of the biomass components can also be achieved by decreasing the temperature below the critical temperature. Separation of the biomass components can also be achieved by differential strength of interaction with a chromatography resin packed into the supercritical chromatography unit 415. In various embodiments, separation can be achieved through any combination of changes in pressure of the fluid, changes in temperature of the fluid, and interactions between the biomass components and a chromatography resin. One or more fractions comprising various biomass components may be recovered from the supercritical chromatograph. In some embodiments, the fractions are recovered in water. In some embodiments, the fractions are sufficiently pure and/or concentrated to be used directly, such as in a fermentation process.

In some cases, the one or more biomass components are recovered from the supercritical or near-supercritical fluid by changing the temperature of the fluid (either raising or lowering the temperature). The temperature can be changed at any suitable rate (e.g., in stages, to fractionate biomass components) or to any suitable extent (e.g., so that biomass components are recovered). In some cases, the fluid is re-heated or re-cooled and used again 410. Recovery of biomass components by changing the temperature may be preferable to recovery of biomass components by pressure changes because thermal energy is more easily recovered (e.g., using a heat exchanger) than mechanical energy in some instances.

The supercritical or near-supercritical fluid can have any suitable polarity. In some instances, the fluid is non-polar (e.g., carbon dioxide). In some embodiments, the fluid is polar (e.g., ammonia). Various fluids can be mixed (in any ratio), for example to achieve a certain polarity.

In some embodiments, the supercritical or near-supercritical fluid comprises a co-solvent. The co-solvent can be used at any suitable concentration (e.g., about 0.1%, about 0.5%, about 1%, about 5%, or about 10% of the mass of the supercritical or near-supercritical fluid).

The co-solvent can be polar or non-polar. In some embodiments, the co-solvent is polar when the supercritical or near-supercritical fluid is non-polar.

The co-solvent can be derived from the biomass and/or present in the hydrolysate. In some embodiments, the co-solvent is selected from water, alcohol, acetic acid, acetate, acetone, carboxylic acids, organic polar acids or any combination thereof.

In some embodiments, one or more biomass components are sequentially extracted from the ionic liquid in a plurality of supercritical or near-supercritical fluids (optionally comprising co-solvents). In some cases, polar biomass components are extracted in a polar supercritical or near-supercritical fluid and non-polar biomass components are extracted in a non-polar supercritical or near-supercritical fluid.

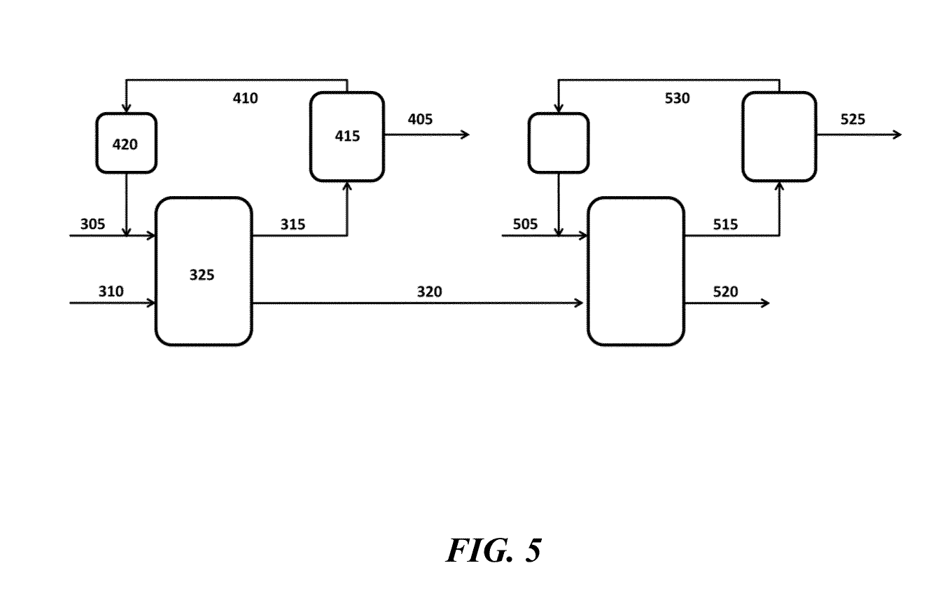

With reference to FIG. 5, where like numbers represent like elements, the ionic liquid mixture 310 is contacted with a first supercritical fluid 310 to form a first post-extraction supercritical fluid mixture 315 and a first post-extraction ionic liquid mixture 320. The first post-extraction ionic liquid mixture is contacted with a second supercritical fluid 505 to form a second post-extraction supercritical fluid mixture 515 and a second post-extraction ionic liquid mixture 520. Biomass components 525 can be recovered from the second post-extraction supercritical fluid mixture and the second supercritical fluid can be re-used 530.

The method can achieve a high recovery of ionic liquid. In some embodiments, ionic liquid is rejected from the supercritical or near-supercritical fluid by increasing the pressure of the fluid. In some embodiments, ionic liquid is rejected from the supercritical or near-supercritical fluid by increasing the pressure of the fluid following extraction and before recovery of the biomass components from the fluid (e.g., increasing the pressure such that the recovered biomass components have less than 0.5%, less than 0.1%, less than 0.05%, less than 0.01%, or less than 0.005% ionic liquid by mass).

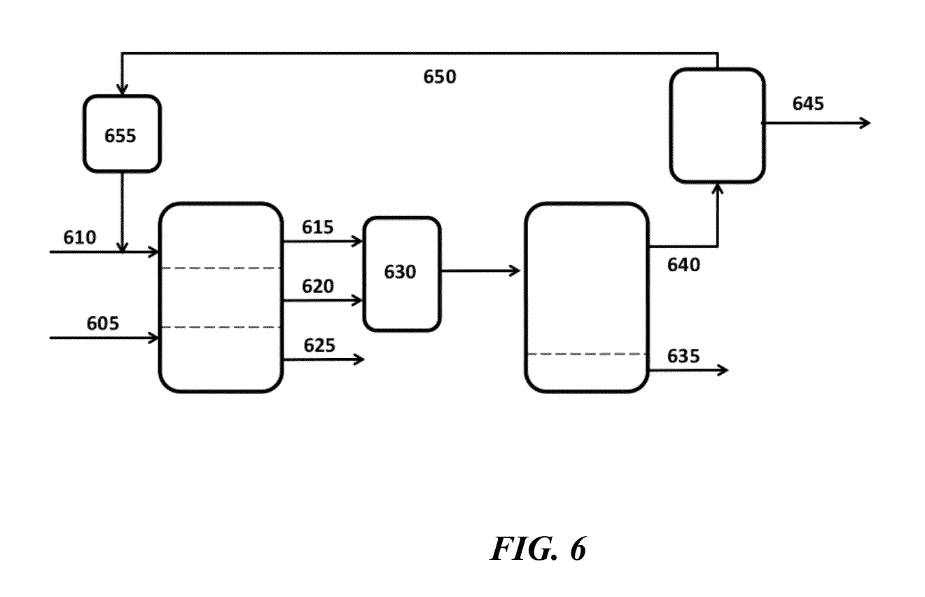

Turning attention to FIG. 6, an ionic liquid mixture comprising biomass components 605 is contacted with a supercritical fluid 610 to form a post-extraction supercritical fluid mixture 615, a post-extraction ionic liquid mixture 625, and optionally an aqueous phase 620. While three phases are shown (represented by dashed phase partitions), in some cases, an aqueous phase 620 is not formed. The ionic liquid mixture and supercritical fluid are contacted at a first pressure and temperature. In some cases, the first pressure and temperature does not reject a sufficiently high proportion of the ionic liquid from the post-extraction supercritical fluid mixture (and/or aqueous phase).

In some cases, the post-extraction supercritical fluid mixture 615 (and optionally an aqueous phase 620) is further compressed 630 to a second pressure. The second pressure further rejects ionic liquid 635 from the fluid. Biomass components can be recovered from the fluid 645 and the fluid can be recompressed 655 and re-used 650.

The composition (comprising one or more biomass components in an ionic liquid) can be obtained in any suitable way, including by dissolving a biomass in an ionic liquid and hydrolyzing the biomass in the ionic liquid as described above. In some instances, the ionic liquid comprises a catalyst. In some instances, the ionic liquid comprises acid (e.g., hydrochloric acid). In some cases, the supercritical or near-supercritical fluid is carbon dioxide and the ionic liquid comprises carbonic acid.

In some instances, the ionic liquid is re-used to dissolve and/or hydrolyze biomass following extraction of biomass components from the ionic liquid (e.g., in a closed-loop process). In some cases, biomass dissolution and/or hydrolysis is more efficient when the concentration of water in the ionic liquid is (e.g., initially) low (e.g., less than 10%, less than 5%, less than 3%, or less than 1%). In some embodiments, water is extracted from the composition in the supercritical or near-supercritical fluid (e.g., to less than 10%, less than 5%, less than 3%, or less than 1%). In some embodiments, following extraction, the concentration of water in the ionic liquid is between 0% and about 10%, between 0% and about 5%, between 0% and about 3%, or between 0% and about 1%.

In some embodiments, the biomass components comprise carbohydrates, the molecular weight of the carbohydrates is reduced in the ionic liquid to form sugars, and the sugars are extracted from the ionic liquid.

### Recovery of Biomass Components in an Aqueous Phase

In another aspect, biomass components are recovered from ionic liquids in an aqueous phase. An aqueous phase is any composition in which water is the major solvent. An aqueous phase may have less than 50% water (e.g., a solution of 51% glucose in 49% water). In contrast, an ionic liquid-rich phase is any composition in which ionic liquid is the major solvent. In some embodiments, the biomass components are not extracted in a supercritical or near-supercritical phase.

Described herein is a multi-phasic system and a method for formation thereof. The multi-phasic system comprises a first phase comprising an ionic liquid; a second phase comprising water and one or more biomass components; and optionally a third phase comprising a fluid.

In some embodiments, the first phase comprises an ionic liquid, as described herein. The first phase (e.g., ionic liquid-rich phase) may contain the majority of the ionic liquid originally in the composition (e.g., at least 80%, at least 90%, at least 95%, or at least 99%). The first phase can comprise at least 50%, at least 60%, at least 70%, at least 80%, at least 90%, at least 95%, or at least 99% ionic liquid by mass in some instances.

In some embodiments, the second phase comprises water, as described herein. The second phase (e.g., aqueous or water-rich phase) may contain the majority of the water originally in the composition (e.g., at least 80%, at least 90%, at least 95%, or at least 99%). In some embodiments, the second phase comprises less than 25%, less than 20%, less than 15%, less than 10%, less than 5%, less than 1%, less than 0.5%, or less than 0.1% ionic liquid by mass (w/w). In some cases, the second phase comprises a detectable amount of ionic liquid (e.g., at least 0.00001% in some instances). The biomass components can be recovered in the second phase (e.g., aqueous phase).

In some embodiments, the third phase comprises a fluid, as described herein. Not all embodiments have a third phase. In some embodiments, there are more than three phases. The fluid can be without limitation a pressurized gas, a liquefied gas, a near-supercritical fluid, or a supercritical fluid. In some embodiments, the fluid is pressurized such that the first phase and second phase form.

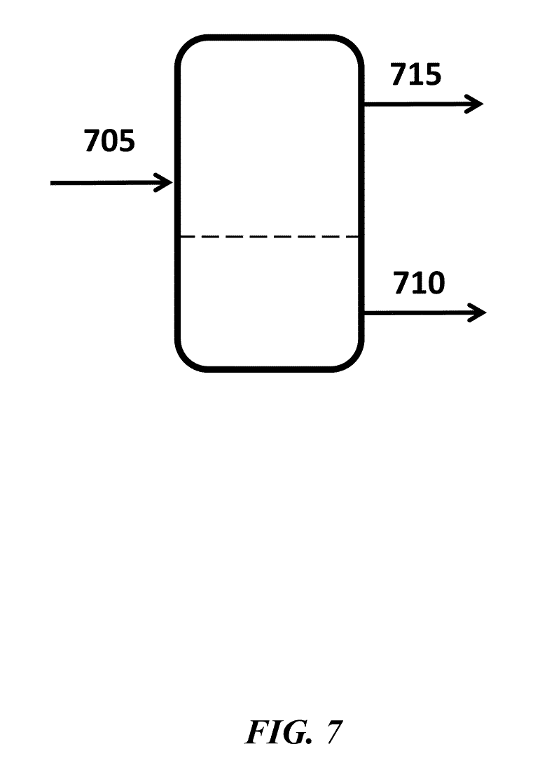

In an aspect, provided herein with reference to FIG. 7 is a method for recovering biomass components from an ionic liquid. The method comprises forming a first phase and a second phase from a hydrolyzed biomass composition 705 comprising an ionic liquid, water and one or more biomass components, wherein the first phase 710 comprises an ionic liquid and the second phase 715 comprises water and one or more biomass components. In some instances, the second phase is portioned from the first phase to recover biomass components. The second phase is not necessarily less dense than the first phase. In some instances, the first phase floats on top of the second phase. In some instances, the second phase floats on top of the first phase.

The hydrolyzed biomass composition can be obtained by hydrolyzing the biomass and/or biomass component in the ionic liquid. In some cases, the biomass component is a sugar (e.g., glucose). The sugar can be recovered in the second (e.g., aqueous) phase. As used herein, compounds (e.g., biomass components, sugars) are recovered when they are removed from the ionic liquid. In some embodiments, recovered biomass components can be used in further methods (e.g., recovered sugars can be fermented). In some cases, recovered, partitioned, separated, purified, isolated are used interchangeably. These terms are not absolute (e.g., the methods do not require complete separation, absolute purity, and the like).

The formation and/or stability of separate ionic liquid-rich and aqueous phases can be affected by the presence of a solute. The solute can be dissolved in the composition comprising ionic liquid and water, can be dissolved in the aqueous phase, can be dissolved in the ionic liquid-rich phase, or any combination thereof. The solute can be added to the composition and/or phases. In some instances, at least some of the solute is derived from the biomass. Examples of solutes (optionally derived from biomass) include, but are not limited to sugar, oil, methanol, or any combination thereof.

In some embodiments, the hydrolysis of biomass provides solute(s) that induce the formation of the first phase and the second phase. Induction of phase formation means that two or more separate phases (e.g., aqueous phase and ionic liquid-rich phase) do not form at a given set of conditions (e.g., temperature and pressure) without the presence of the solute. Induction of phase formation can also mean that two or more separate phases (e.g., aqueous phase and ionic liquid-rich phase) form under a given set of conditions (e.g., temperature and pressure) with the presence of the solute. In some instances, phases and/or separate phases are compositions that are immiscible or partially miscible with each other. In some cases, phases and/or separate phases have different densities from each other. In some cases, phases and/or separate phases have different major components (e.g., solvents such as water or ionic liquid) from each other.

In some embodiments, the hydrolysis of biomass provides solute(s) that at least partially stabilize the second (aqueous) phase. Stabilization of phases means that two or more separate phases (e.g., aqueous phase and ionic liquid-rich phase) remain distinct for a longer period of time at a given set of conditions (e.g., temperature and pressure) with the solute present when compared to without the presence of the solute.

In some embodiments, the solutes are hydrogen bonding solutes. A hydrogen bonding solute is any molecule capable of forming one or more hydrogen bonds. In some cases, the hydrogen bonding solute is capable of forming one or more hydrogen bonds with an ionic liquid and/or water. The hydrogen bonding solute can have at least one hydroxyl group. In various embodiments, the hydrogen bonding solute can be a carbohydrate, a sugar, an aldose, a ketose, or any combination thereof. In some cases, the hydrogen bonding solute is derived from biomass. Glucose is an example of a hydrogen bonding solute.

The concentration of the solute (e.g., hydrogen bonding solute, optionally derived from biomass and/or a biomass component) in the composition comprising ionic liquid and water can be any suitable concentration (e.g., for the formation and/or stability of phases). In some embodiments, the concentration of the solute in the composition is about 0.01%, about 0.05%, about 0.1%, about 0.5%, about 1%, about 2%, about 4%, about 6%, about 8%, about 10%, about 15%, about 20%, or about 25%. In some embodiments, the concentration of the solute in the composition is at least 0.01%, at least 0.05%, at least 0.1%, at least 0.5%, at least 1%, at least 2%, at least 4%, at least 6%, at least 8%, at least 10%, at least 15%, at least 20%, or at least 25%. In some embodiments, the concentration of the solute in the composition is between 1% and 25%. In some cases, the concentration of the solute in the composition is at least high enough to induce the formation of an aqueous phase. In some cases, the concentration of the solute in the composition is at least high enough to stabilize an aqueous phase.

Following the formation of an aqueous phase, the concentration of the solute in the aqueous phase can be any suitable concentration (e.g., for the stability of phases). In some instances, the concentration of the solute is higher in the aqueous phase than the concentration of the solute in the ionic liquid phase and/or in the composition before the formation of phases. In some embodiments, the concentration of the solute is at least 10%, at least 20%, at least 50%, at least 100%, or at least 200% higher in the aqueous phase than the concentration of the solute in the ionic liquid phase and/or in the composition before the formation of phases.

In some embodiments, the concentration of the solute in the aqueous phase is about 0.1%, about 0.5%, about 1%, about 2%, about 4%, about 6%, about 8%, about 10%, about 15%, about 20%, about 25%, about 30%, about 40%, about 50%, about 60%, or about 70%. In some embodiments, the concentration of the solute in the aqueous phase is at least 0.1%, at least 0.5%, at least 1%, at least 2%, at least 4%, at least 6%, at least 8%, at least 10%, at least 15%, at least 20%, at least 25%, at least 30%, at least 40%, at least 50%, at least 60%, or at least 70%. In some cases, the concentration of the solute in the aqueous phase is at least high enough to induce the formation of an aqueous phase. In some cases, the concentration of the solute in the aqueous phase is at least high enough to stabilize an aqueous phase.

In some embodiments, the hydrolyzed biomass composition and/or solute can be obtained by hydrolyzing the biomass in the ionic liquid. As described above, hydrolysis can involve the addition of water to a hydrolysis reaction. The amount and/or rate of water addition can be used to control the concentration of the solute in the composition and/or aqueous phase. In some embodiments, the concentration of the water in the hydrolysis reaction is such that the concentration of the solute in the second phase is near saturation (e.g., at least 50%, at least 70%, at least 90%, at least 95%, or at least 99% of saturation). In some cases, the solute is a sugar or mixture of sugars. In some instances, the solubility of a sugar or mixture of sugars in the aqueous phase is between about 3% and 78% by mass at 25° C. In some instances, the solubility of a sugar or mixture of sugars in the aqueous phase is between about 55% and 67% by mass.

In some embodiments, water is added to the hydrolysis reaction at a rate such that the concentration of ionic liquid in the aqueous phase (e.g., second phase) is low (e.g., less than 25% by mass, less than 15%, less than 10%, less than 5%, less than 1%, less than 0.5%, or less than 0.1% ionic liquid by mass).

The temperature of the first phase, second phase and/or composition can be any of a variety of suitable temperatures (e.g., for the formation or stability of an aqueous phase). In some instances, the temperature of the composition is reduced to form the first phase and the second phase (e.g., reduced from the temperature at which hydrolysis is performed). In some embodiments, the temperature is about 50° C., about 45° C., about 40° C., about 35° C., about 30° C., about 25° C., about 20° C., about 15° C., about 10° C., or about 5° C. In some embodiments, the temperature is less than 50° C., less than 45° C., less than 40° C., less than 35° C., less than 30° C., less than 25° C., less than 20° C., less than 15° C., less than 10° C., less than 5° C., or less than 0° C. In some embodiments, the temperature is less than ambient temperature (e.g., room temperature, the temperature of the outdoor weather and/or building in which the process is housed).

In some embodiments, the composition and/or first phase and second phase are pressurized. The pressure can be any of a variety of suitable pressures (e.g., a pressure that provides for the formation or stability of an aqueous phase). In some instances, the pressure of the composition and/or first phase and second phase is greater than atmospheric pressure. In some embodiments, the pressure is about 1 bar, about 2 bar, about 5 bar, about 10 bar, about 20 bar, about 30 bar, about 40 bar, about 50 bar, about 100 bar, or about 200 bar. In some embodiments, the pressure is at least 1 bar, at least 2 bar, at least 5 bar, at least 10 bar, at least 20 bar, at least 30 bar, at least 40 bar, at least 50 bar, at least 100 bar, or at least 200 bar.

In some cases, the fluid is non-polar. In some embodiments, the fluid comprises carbon dioxide. In some embodiments, the composition and/or first phase and second phase are in contact with a pressurized gas. In some cases, the composition is contacted with pressurized carbon dioxide to form the first phase and the second phase.

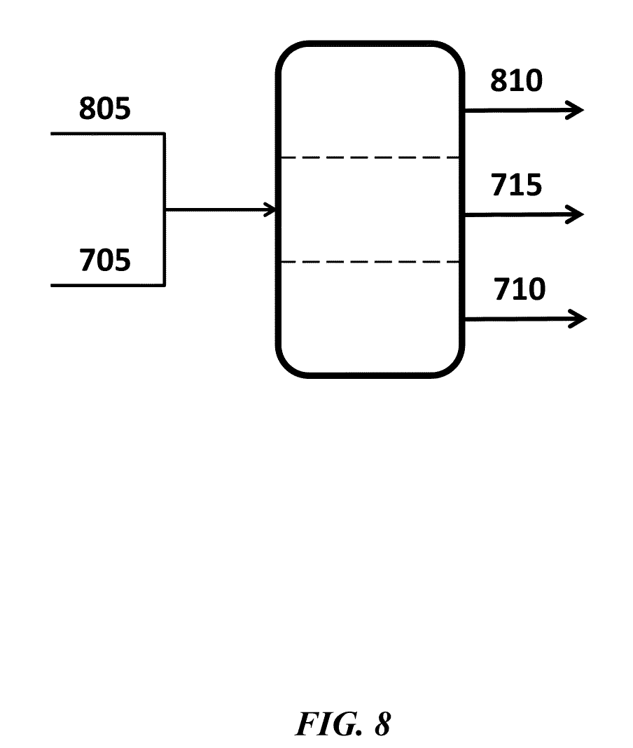

In an aspect, provided herein is a method for recovering biomass components from an ionic liquid. With reference to FIG. 8, where like numerals indicate like elements, the method comprises contacting a composition 705 comprising an ionic liquid, water and a hydrogen bonding solute with a fluid 805 to form a first phase 710 comprising an ionic liquid and a second phase 715 comprising water and the hydrogen bonding solute. Contacting the composition with the fluid may form a third phase 810 comprising the fluid. The relative positions of the phases in FIG. 8 do not necessarily imply their relative densities.

In some embodiments, the method further comprises partitioning the second phase from the first phase. The phases can be partitioned in any suitable way. In some cases, the phases are piped (e.g., by a pump) from different regions of a vessel. In some cases, the phases have different densities and a less dense phase is drawn from an upper portion of a vessel and/or a more dense phase is drawn from a lower portion of a vessel. In some instances, centrifugation, filtration, decantation, or any suitable method can be used to partition the phases. In some instances, phases are not in contact with each other when they are partitioned from each other.

In some embodiments, the fluid is a pressurized gas. The gas can be pressurized to any suitable pressure (e.g., for the formation of the phases). In some embodiments, the gas is pressurized to about 1 bar, about 2 bar, about 5 bar, about 10 bar, about 20 bar, about 30 bar, about 40 bar, about 50 bar, about 100 bar, or about 200 bar. In some embodiments, the gas is pressurized to at least 1 bar, at least 2 bar, at least 5 bar, at least 10 bar, at least 20 bar, at least 30 bar, at least 40 bar, at least 50 bar, at least 100 bar, or at least 200 bar. In some embodiments, the fluid is a liquefied gas. In some instances, the composition is contacted with the fluid at a pressure greater than atmospheric pressure.

In some embodiments, the fluid is a supercritical or near-supercritical fluid. The fluid can be pressurized to about 1%, about 5%, about 10%, about 25%, about 50%, about 75%, about 90%, about 95%, or about 99% of the critical pressure of the fluid. In some embodiments, the fluid is pressurized to at least 1%, at least 5%, at least 10%, at least 25%, at least 50%, at least 75%, at least 90%, at least 95%, or at least 99% of the critical pressure of the fluid.

In some cases, contacting the composition with the fluid increases the rate at which the aqueous phase is formed (e.g., increases the rate by at least 5 times, at least 10 times, at least 20 times, at least 30 times, at least 50 times, at least 500 times, or at least 5000 times). In some cases, the aqueous phase is formed in less than 1 minute, less than 5 minutes, less than 10 minutes, less than 30 minutes, or less than 2 hours.

Contacting the composition with the fluid may decrease the viscosity of the composition. In some instances, decreasing the viscosity of the composition increases the rate at which the aqueous phase forms. In some embodiments, the viscosity of the first phase is less than the viscosity of the composition without contact with the fluid. Viscosity generally refers to dynamic viscosity and can be measured in units of pascal-second. In some embodiments, the viscosity of the composition is decreased by at least 1%, at least 5%, at least 10%, at least 25%, at least 50% less, or at least 75%. In some embodiments, the viscosity of the first phase is at least 1%, at least 5%, at least 10%, at least 25%, at least 50% less, or at least 75% less than the viscosity of the composition without contact with the fluid.

The ionic liquid can be any ionic liquid. In some cases, the ionic liquid is a biomass dissolving ionic liquid. In some embodiments, the ionic liquid is hydrophilic. In some instances, the ionic liquid comprises a chloride anion. The ionic liquid is not 1-butyl-3-methylimidazolium tetrafluoroborate (i.e., [C4mim][BF4]) or 1-butyl-3-methylimidazolium trifluoromethanesulfonate (i.e., [C4mim][CF3 SO3]) in some embodiments. In some embodiments, the ionic liquid has a hydrogen bond basicity (13) greater than 0.57. In some embodiments, the dielectric constant of the first phase (e.g., ionic liquid-phase) is less than the dielectric constant of the ionic liquid.

### Continuous Recovery

Methods for hydrolyzing biomass and methods for recovering biomass components from ionic liquids are described herein. Performing hydrolysis and recovering continuously can have certain advantages including recovery of high quality biomass components (e.g., at a high concentration and/or with few breakdown products).

In an aspect, provided herein is a method for producing fermentable sugar. The method comprises hydrolyzing a polysaccharide in an ionic liquid to produce sugar and continuously removing the sugar from the ionic liquid. In some embodiments, the rate of sugar removal from the ionic liquid is approximately equal to the rate of sugar production. The sugar may be continuously removed by extraction in a supercritical or near-supercritical fluid for example.

The concentration of furanic compounds can be any concentration. In some embodiments, the sugars contain little furanic compounds. In some cases, the sugar is fermentable when removed from the ionic liquid. In some embodiments, the mass of furanic compounds in the sugar is about 30%, about 20%, about 10%, about 5%, about 3%, about 1%, about 0.5%, or about 0.1% of the mass of sugar produced in the ionic liquid. In some embodiments, the mass of furanic compounds in the sugar is at most 30%, at most 20%, at most 10%, at most 5%, at most 3%, at most 1%, at most 0.5%, or at most 0.1% of the mass of sugar produced in the ionic liquid.

In some embodiments, the sugar is removed from the ionic liquid at an optionally variable rate such that the mass of furanic compounds produced is about 30%, about 20%, about 10%, about 5%, about 3%, about 1%, about 0.5%, or about 0.1% of the mass of sugar produced in the ionic liquid. In some embodiments, the sugar is removed from the ionic liquid at an optionally variable rate such that the mass of furanic compounds produced is less than 30%, less than 20%, less than 10%, less than 5%, less than 3%, less than 1%, less than 0.5%, or less than 0.1% of the mass of sugar produced in the ionic liquid.

The hydrolysis reaction can break glycosidic bonds and/or decrease the degree of polymerization of the polysaccharide. Supercritical and near-supercritical fluids can extract smaller molecules from ionic liquids more efficiently than larger molecules in some instances. Coupling hydrolysis with sugar recovery by fluid extraction (e.g., supercritical and near-supercritical fluids) separates sugars (e.g., monosaccharides, disaccharides, small oligosaccharides up to about 3, 4, 5, or 6 sugar units) from larger polysaccharides in some instances. The polysaccharides can remain in the hydrolysis reaction and/or be returned to the hydrolysis reaction until the degree of polymerization is reduced to such an extent that the hydrolysate (e.g., sugars) become extractable in the fluid. In some embodiments, the product is continuously separated from the reactant (e.g., sugars from polysaccharides).

In some embodiments, the hydrolysis reaction is cooled. Provided herein is a method for producing fermentable sugar comprising hydrolyzing a polysaccharide in an ionic liquid to produce sugar and continuously cooling and/or lowering the temperature of the hydrolysate. The hydrolysate can be cooled such that a low concentration of furanic compounds are formed for example.

### Furanic Compounds

In some cases, production of furanic compounds is desired. Furanic compounds are considered to be biomass components and biomass derivatives. The composition comprising a furanic compound can be produced by contacting an ionic liquid with a biomass, a polysaccharide, a sugar, or a combination thereof. A method for producing furanic compounds from biomass is described in U.S. Patent Pub. No. 2010/0004437, which is herein incorporated by reference in its entirety. In some embodiments, the ionic liquid further comprises a catalyst. In some embodiments, the catalyst dehydrates the sugar (e.g., to a furanic compound). In some cases, the catalyst is CrCl₃. The furanic compound can be, but is not limited to hydroxymethylfurfural, 2,5-dimethylfuran, furfural, or a combination thereof.

In an aspect, provided herein is a method for recovering a furanic compound from an ionic liquid comprising contacting a composition comprising a furanic compound and an ionic liquid with a fluid. In various embodiments, the fluid is a pressurized gas, liquefied gas, or supercritical or near-supercritical fluid. In some instances, the furanic compound is extracted in the supercritical or near-supercritical fluid.

In some embodiments, contacting the ionic liquid with a fluid forms a first phase comprising the ionic liquid and a second phase comprising the furanic compound and the furanic compound is recovered from the ionic liquid by partitioning the second phase from the first phase. In some cases, at least 90% of the ionic liquid is in the first phase and at least 90% of the furanic compound is in the second phase.

In some embodiments, the ionic liquid comprises water, contact with the fluid creates an aqueous phase, and the furanic compound is recovered in the aqueous phase.

In some embodiments, the ionic liquid comprises water, contact with the fluid creates an organic phase, and the furanic compound is recovered in the organic phase.

### Ionic Liquid Manufacture and Purification

The methods described herein are not limited to processing of biomass and/or recovery of biomass components from ionic liquids. The methods can be used to remove any solute from an ionic liquid (e.g., increase the purity of the ionic liquid). In some embodiments, the methods are used in the manufacture and/or purification of ionic liquids.

In an aspect, provided herein is a method for manufacturing or purifying an ionic liquid, comprising removing non-ionic components from the ionic liquid by contacting the ionic liquid with a pressurized gas. In some embodiments, the pressurized gas is carbon dioxide. In some embodiments, the pressurized gas is a supercritical or near-supercritical fluid. The non-ionic component can be any compound that is not charged. The non-ionic component can be polar. Water is an example of a non-ionic component that can be removed using the methods described herein.

The ionic liquid can be manufactured in any suitable way. In some embodiments, the ionic liquid is synthesized by mixing ionic components (optionally comprising non-ionic impurities) prior to removing non-ionic components from the ionic liquid. In some embodiments, the ionic liquid is synthesized by creating ionic components in a reaction prior to removing non-ionic components from the ionic liquid. The reaction can generate non-ionic by-products, non-ionic components may be impurities in the reactants, non-reacted reactants can be non-ionic components, and the like.

The ionic liquid can be synthesized in any suitable reactor, optionally in a microrcactor. The ionic liquid can be synthesized from any suitable starting materials. In one example, a base is reacted with an alkylating agent in a quaternization reaction, which is then reacted with a molecule that serves as an anion source in a metathesis reaction.

### Recovered Biomass Components

The biomass components recovered from the ionic liquids are relatively clean, pure and/or concentrated in some embodiments. The invention includes the biomass components produced by any of the methods described herein.

Sugars are one example of a biomass component. The sugar can include, but is not limited to glucose, xylose, mannose, or a combination thereof. In some cases, the sugars are recovered from the ionic liquid as a solution (e.g., dissolved in a solvent such as water). In an aspect, described herein is a sugar composition comprising water and a sugar, wherein the sugar is derived from cellulose, hemicellulose, or a combination thereof. The sugar can further comprise carbon dioxide and/or ionic liquid.

The sugar composition can comprise any concentration of carbon dioxide (e.g., at any detectable concentration). In some instances, the concentration of carbon dioxide is about 0.0001%, about 0.0005%, about 0.001%, about 0.005%, about 0.01%, about 0.05%, about 0.1%, or about 0.5% by mass. In some instances, the concentration of ionic liquid is less than 0.0001%, less than 0.0005%, less than 0.001%, less than 0.005%, less than 0.01%, less than 0.05%, less than 0.1%, less than 0.5% by mass.

In some cases, the sugar composition comprises ionic liquid (e.g., at any detectable concentration). In some instances, the concentration of ionic liquid is about 0.001%, about 0.005%, about 0.01%, about 0.05%, about 0.1%, about 0.5%, about 1%, or about 5% by mass. In some instances, the concentration of ionic liquid is less than 0.001%, less than 0.005%, less than 0.01%, less than 0.05%, less than 0.1%, less than 0.5%, less than 1%, or less than 5% by mass.

In an aspect, provided herein is a fermentable sugar comprising a sugar and an ionic liquid, wherein the sugar is derived from cellulose, hemicellulose, or a combination thereof. In some embodiments, the ionic liquid is detectable and the mass of sugar is at least 5 times, at least 10 times, at least 20 times, at least 50 times, at least 100 times, at least 1000 times, at least 10000 times, or at least 100000 times greater than the mass of the ionic liquid. In some cases, the sugar is fermentable.

In some embodiments, the sugar comprises at least one component selected from furanics, phenols, ethers, aldehydes, ash, lignin, and lignin derivatives. In some embodiments, the concentration of the furanics, phenols, ethers, aldehydes, ash, lignin, and lignin derivatives, or any combination thereof is less than 10%, less than 5%, less than 1%, less than 0.5%, less than 0.1%, less than 0.05%, or less than 0.01% by mass (w/w).

Oils are one example of a biomass component. The oils can include, but are not limited to terpenes, tall oils, lipids, triglycerides, or any combination thereof. In some cases, the oils are recovered from the ionic liquid. In an aspect, described herein is an oil comprising carbon dioxide and/or ionic liquid, wherein the oil is derived from biomass.

The oil can comprise any concentration of carbon dioxide (e.g., at any detectable concentration). In some instances, the concentration of carbon dioxide is about 0.0001%, about 0.0005%, about 0.001%, about 0.005%, about 0.01%, about 0.05%, about 0.1%, or about 0.5% by mass. In some instances, the concentration of ionic liquid is less than 0.0001%, less than 0.0005%, less than 0.001%, less than 0.005%, less than 0.01%, less than 0.05%, less than 0.1%, less than 0.5% by mass.

In some cases, the oil comprises ionic liquid (e.g., at any detectable concentration). In some instances, the concentration of ionic liquid is about 0.001%, about 0.005%, about 0.01%, about 0.05%, about 0.1%, about 0.5%, about 1%, or about 5% by mass. In some instances, the concentration of ionic liquid is less than 0.001%, less than 0.005%, less than 0.01%, less than 0.05%, less than 0.1%, less than 0.5%, less than 1%, or less than 5% by mass.

Also encompassed within the invention are the nucleic acids, proteins, lipids, fatty acids, resin acids, waxes, terpenes, acetates (e.g., ethyl acetate, methyl acetate), carbohydrates, cellulose, hemicellulose, alcohols, sugars, sugar acids, glucose, fructose, xylose, galactose, arabinose, mannose, rhamnose, mannuronic acid, galacturonic acid, lignin, alcohols (e.g., methanol, ethanol), phenols, aldehydes, ethers, p-coumaryl alcohol, coniferyl alcohol, sinapyl alcohol, pectin, D-galacturonic acid, amino acids, acetic acid, ash, any derivative thereof (e.g., furanic compounds), or any combination thereof produced by the methods described herein.

### Certain Definitions

Unless defined otherwise, all technical and scientific terms used herein have the same meaning as commonly understood by those of ordinary skill in the art to which the invention belongs. Although any methods and materials similar or equivalent to those described herein can be used in the practice or testing of the present invention, preferred methods and materials are described.

The term “invention” or “present invention” as used herein is not meant to be limiting to any one specific embodiment of the invention but applies generally to any and all embodiments of the invention as described in the claims and specification.

As used herein, the singular forms “a”, “an”, and “the” include plural references unless the context clearly dictates otherwise. Thus, for example, references to “the method” includes one or more methods, and/or steps of the type described herein which will become apparent to those persons skilled in the art upon reading this disclosure.

### EXAMPLES

### Example 1

### Extraction of Glucose with Supercritical Carbon Dioxide

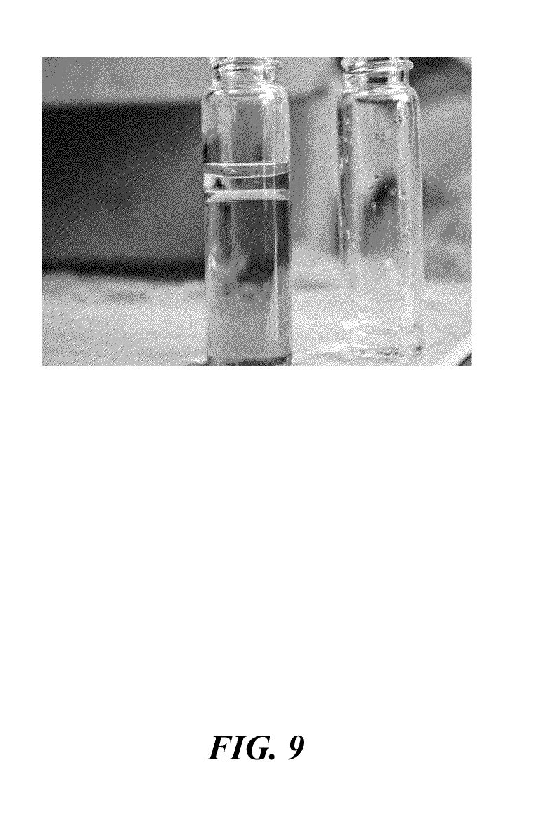

A 10 ml sample containing 85% ionic liquid 1-Butyl-3-methylimidazolium chloride, 10% water, and 5% glucose by mass was prepared. The solution was placed in a pressure vessel and pressurized using supercritical carbon dioxide at 2000 psi and 40° C. and left under these conditions for 15 minutes. Carbon dioxide was then flowed through the pressure vessel at 5 standard liters per minute for 10 minutes. Water was added to the carbon dioxide stream as a co-solvent at a rate of 2 ml/min. The carbon dioxide leaving the vessel was depressurized and vented while a minimal amount of extract from the ionic liquid-water-glucose solution was captured in a collection vial whereupon the carbon dioxide was shut-off and the pressure vessel was depressurized. FIG. 9 shows the sample with a clear phase on top shortly after removal from the pressure vessel.

A Bayer Breeze 2 Glucose Meter measured 529 mg/dL glucose in the clear phase immediately after extraction. The liquid captured from the depressurized extract stream was also measured immediately with no detectible levels of glucose found. This sample was then dried in an oven over several hours leaving observable deposits and particulates. Then, 0.03 mL of DI water was added to the dried sample and tested for glucose giving a reading of 49 mg/dL.

### Example 2

### Extraction of Glucose with Supercritical Carbon Dioxide

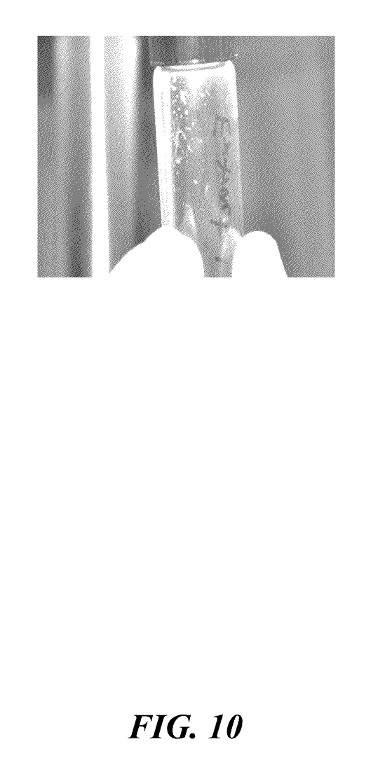

A 13 ml sample containing 80% ionic liquid 1-Butyl-3-methylimidazolium chloride, 10% water, and 10% glucose by mass was prepared. The solution was placed in a pressure vessel and pressurized using supercritical carbon dioxide at 3000 psi and 40° C. and left under these conditions for 17 minutes. Carbon dioxide was then flowed through the pressure vessel at 3.5 standard liters per minute for 39 minutes. Water was added to the carbon dioxide stream as a co-solvent at a rate of 0.75 ml/min. The carbon dioxide leaving the vessel was depressurized and vented while extract from the ionic liquid-water-glucose solution was captured in a collection vial. The collected extract was whitish in color. The collected Extract is shown in FIG. 10.

### Example 3

### Extraction of Glucose with Supercritical Carbon Dioxide

A 13 ml sample containing 80% ionic liquid 1-Butyl-3-methylimidazolium chloride, 10% water, and 10% glucose by mass was prepared. The solution was placed in a pressure vessel and pressurized using supercritical carbon dioxide at 3000 psi and 40° C. Carbon dioxide was then flowed through the pressure vessel at 3.5 standard liters per minute. Water was added to the carbon dioxide stream as a co-solvent at a rate of 2.0 ml/min. The carbon dioxide leaving the vessel was depressurized and vented while extract from the ionic liquid-water-glucose solution was captured in a collection vial.

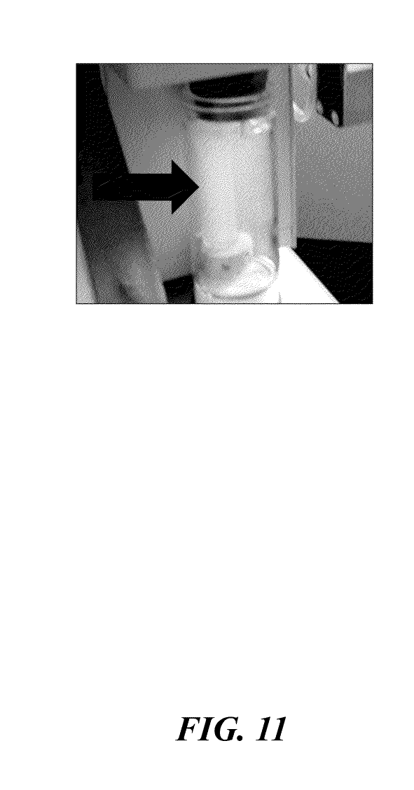

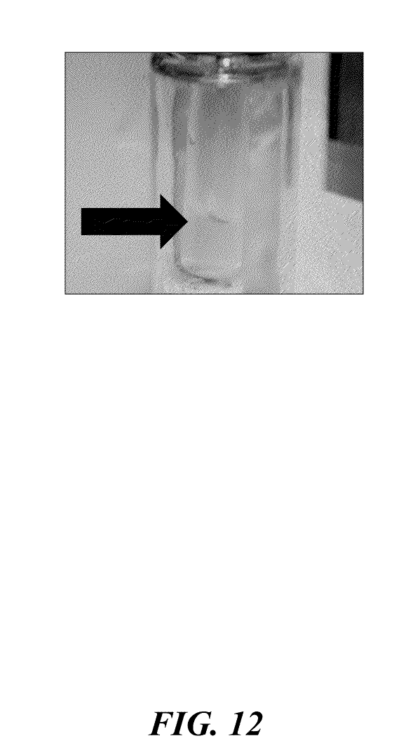

After 25 minutes of extraction, the collection vessel began to fog up with vapor. FIG. 11 shows an image of the collection vessel filling with vapor. Shortly after the collection vessel filled with vapor, liquid extract was captured. FIG. 12 shows collected liquid extract during the experiment.

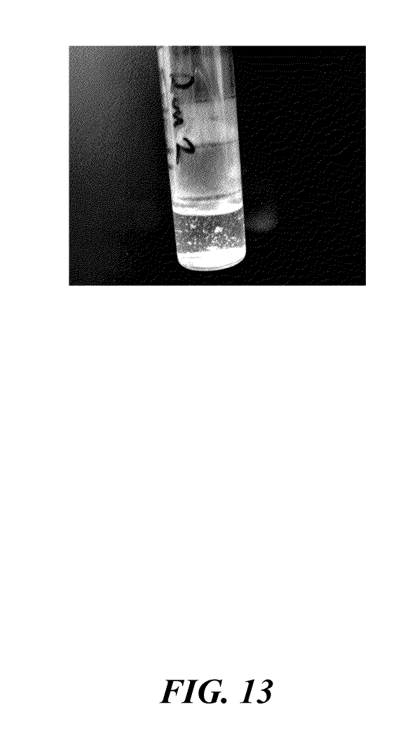

The collected liquid extract was concentrated by vacuum drying. While being concentrated under vacuum, small amounts of a very fine precipitate formed. FIG. 13 shows these particulates. The collected extract continued to concentrate under vacuum until visibly dry.

After drying, approximately 0.05 mL of water was added to the dried extract. The sample was tested for glucose using a Bayer Breeze 2 Glucose Meter which detected glucose giving a reading of “High”. An additional half milliliter of water was added to the sample and retested giving a reading of 173 mg/dL.

### Example 4

### Recovery of Glucose from an Ionic Liquid in an Aqueous Phase

An 11.5 mL solution of 90% ionic liquid 1-Butyl-3-methylimidazolium chloride and 10% glucose by weight was prepared. The sample was warmed and shaken until the glucose was visibly dissolved.

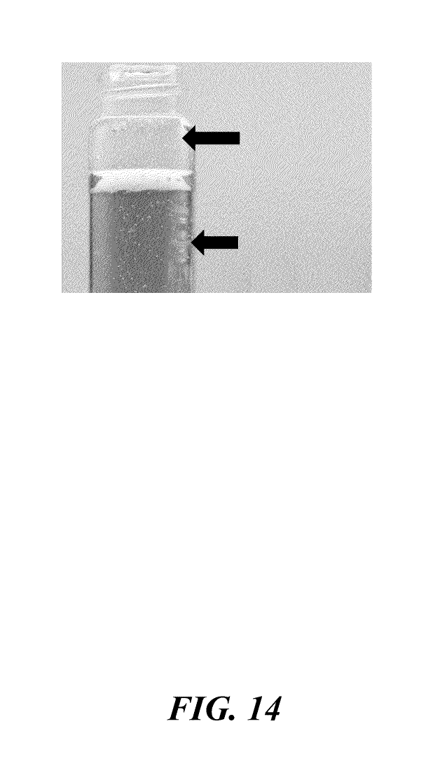

3.5 ml of water was added to the top of the sample with care taken to maintain an ionic liquid-water-glucose phase on the bottom and a visually immiscible water phase on top. FIG. 14 shows a representative illustration of the phase behavior where the immiscible top phase of water and bottom phase of ionic liquid-glucose solution are present.

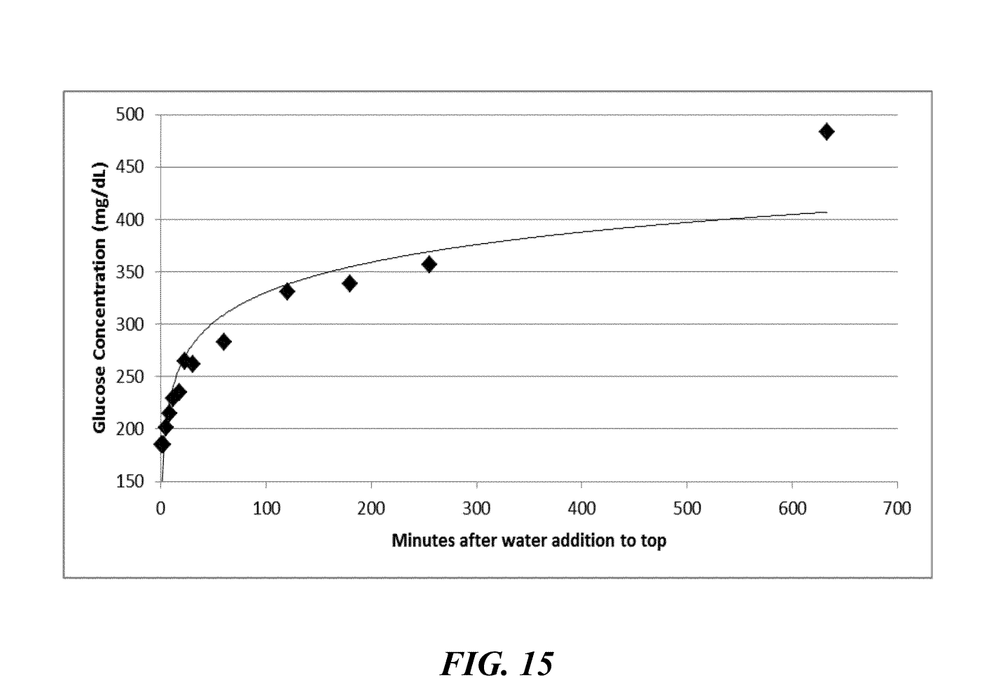

Using a Bayer Breeze 2 Glucose Meter the top of the water phase was immediately measured for glucose. The initial reading was 185 mg/dL glucose. Additional readings were taken every few minutes for an hour and then every few hours for eleven hours. After an initial and rapid increase in glucose concentration the glucose concentration in the water phase began to stabilize at approximately 300 minutes. FIG. 15 shows the glucose concentration in the water phase over time when added on top of an ionic liquid-glucose solution.

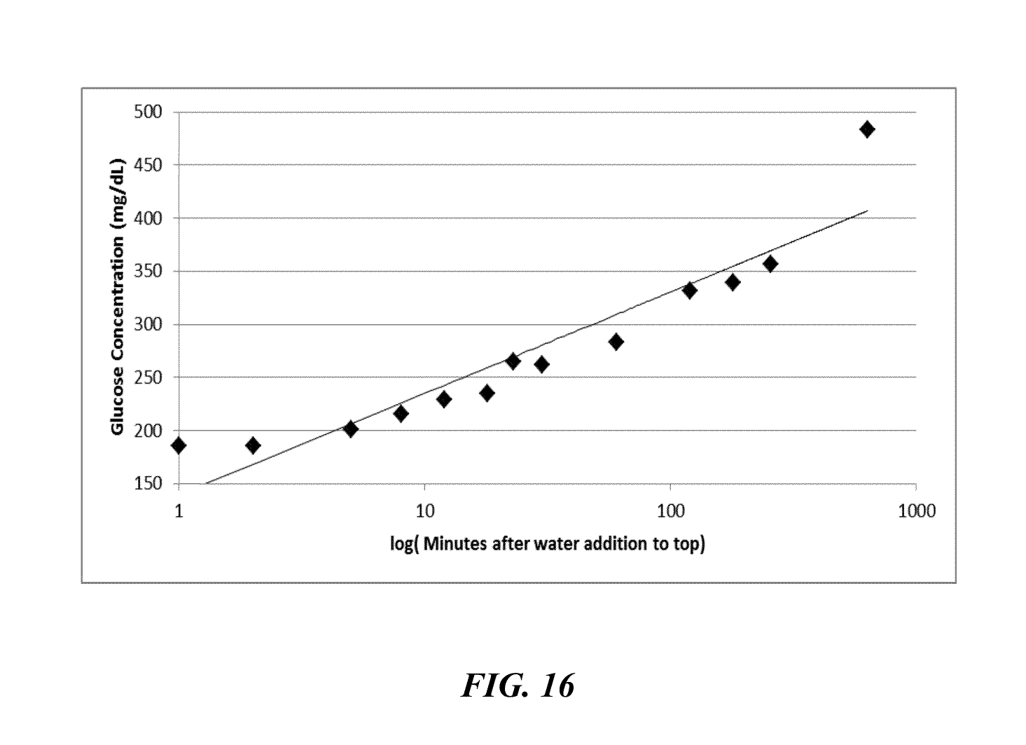

These same data were plotted on a log scale for time and show a very good semi-log fit between 3 and 300 minutes. FIG. 16 shows the glucose concentration in the water phase over the logarithmic time from when water was added on top of the liquid-glucose solution.

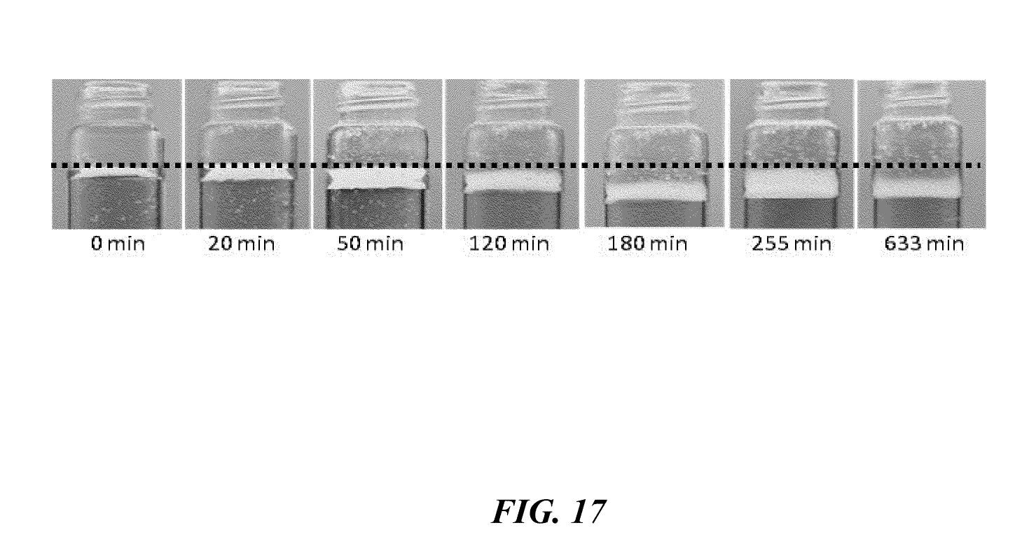

Throughout the experiment it was also observed that the distinct meniscus separating the ionic liquid-glucose bottom phase and the added water top phase gradually became blurred; however the water phase appeared generally unchanged on the top, and the ionic liquid-glucose region blurred by water generally appeared to remain at the same level of the original meniscus. FIG. 17 shows this phenomenon over time.

### Example 5

### Recovery of Glucose from an Ionic Liquid in an Aqueous Phase

Four solutions of 90% ionic liquid 1-Butyl-3-methylimidazolium chloride and 10% water by weight were prepared. Increasing amounts of glucose were added to each sample such that the four samples contained 0%, 3.3%, 6.6%, and 10% glucose. The samples were warmed and shaken until the glucose was visibly dissolved.

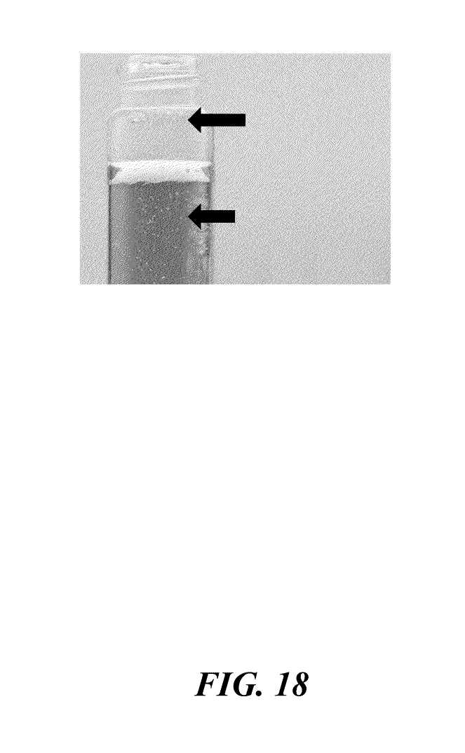

5 ml of water was added to the top of each sample with care taken to maintain an ionic liquid-water-glucose phase on the bottom and a visually immiscible water phase on top. FIG. 18 shows a representative illustration of the phase behavior where the immiscible top phase of water and bottom phase of ionic liquid-water-glucose solution are present.

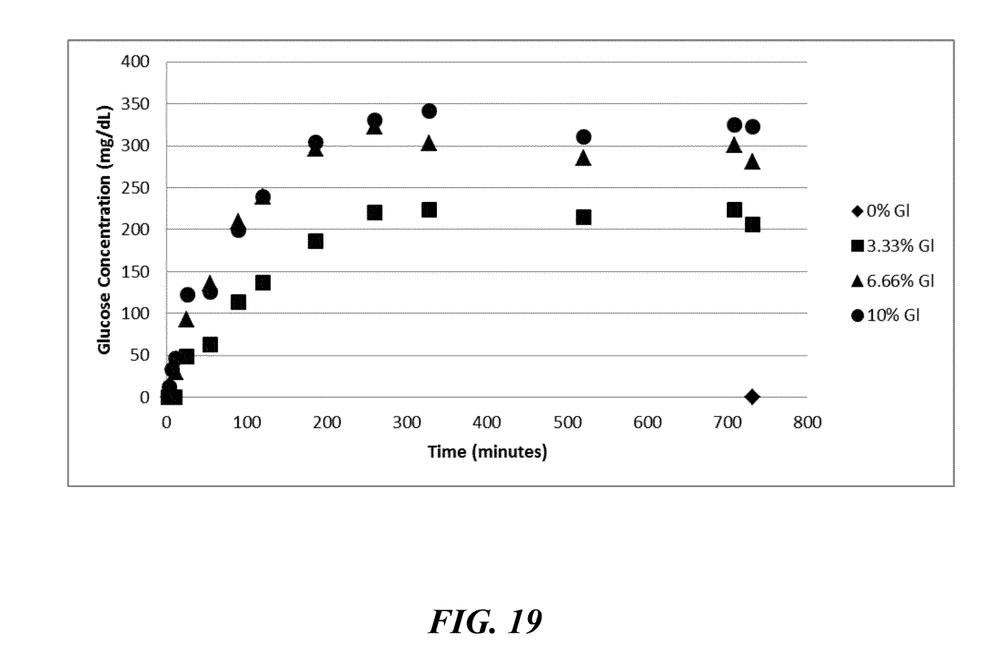

Using a Bayer Breeze 2 Glucose Meter the top of the water phase was measured for glucose. Glucose measurements were taken in this manner during a period of 12 hours. FIG. 19 shows the glucose concentration in the water phase for the four samples prepared containing varying amounts of glucose. After approximately 300 minutes, the increasing glucose migrating into the water phase tapered off.

After 12 hours, 2 ml of the added water phase on top of the ionic liquid-water-glucose solution was removed, diluted, and measured for conductivity using an Extech Instruments ExStik II Conductivity/TDS/Salinity Meter.

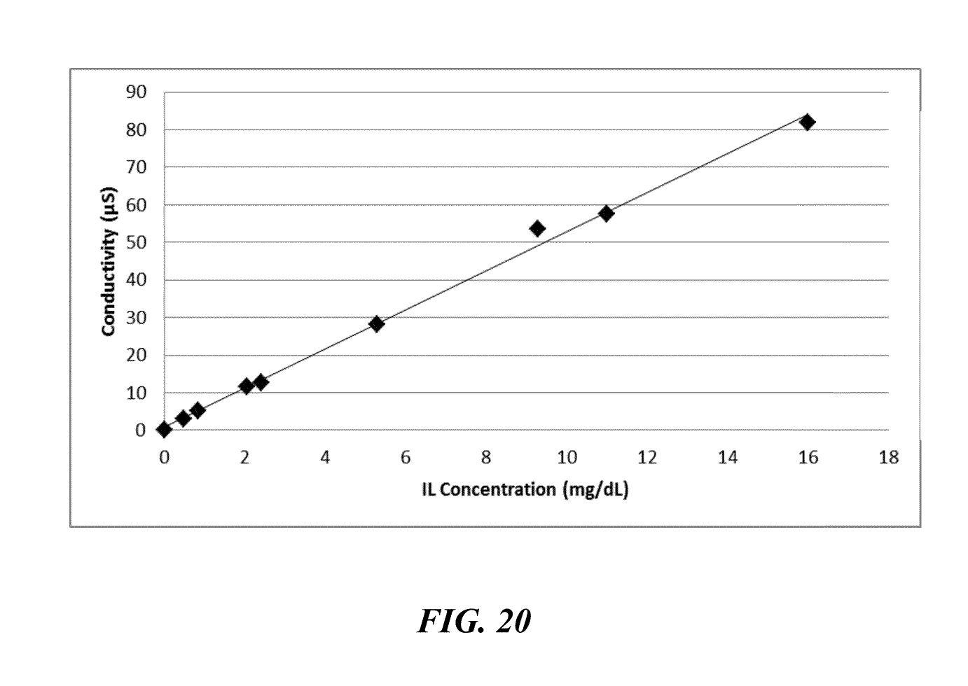

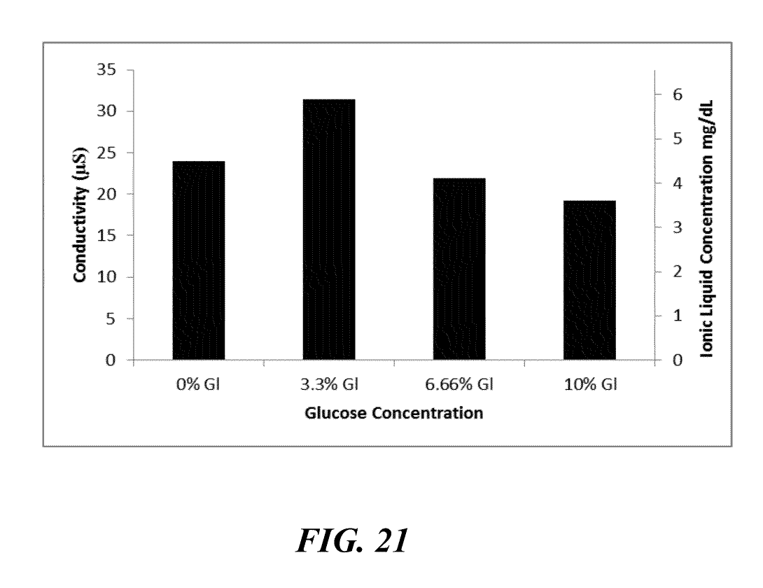

Conductivity was correlated to an ionic liquid concentration from experimental data measuring the conductivity of an ionic liquid solution prepared at various concentrations in deionized water. FIG. 20 shows the relationship of ionic liquid concentration to conductivity. FIG. 21 shows the conductivity and corresponding ionic liquid concentration of the added water phase after 12 hours.

The ionic liquid found in the water phase was approximately 5 mg/dL. For 5 mg/dL of ionic liquid from the ionic liquid-water-glucose solution to dissolve into the added water phase, less than 0.4 mg/dL glucose could also be present. The measured glucose was found to be far greater at approximately 300 mg/dL glucose. The 300 mg/dL glucose indicates that glucose migrated from the ionic liquid-water-glucose phase into the water phase at a rate much greater than expected 0.4 mg/dL glucose simply due from the ionic liquid-water-glucose solution dissolving directly into the water phase.

### Example 6

### Stabilization of an Aqueous Phase with Glucose

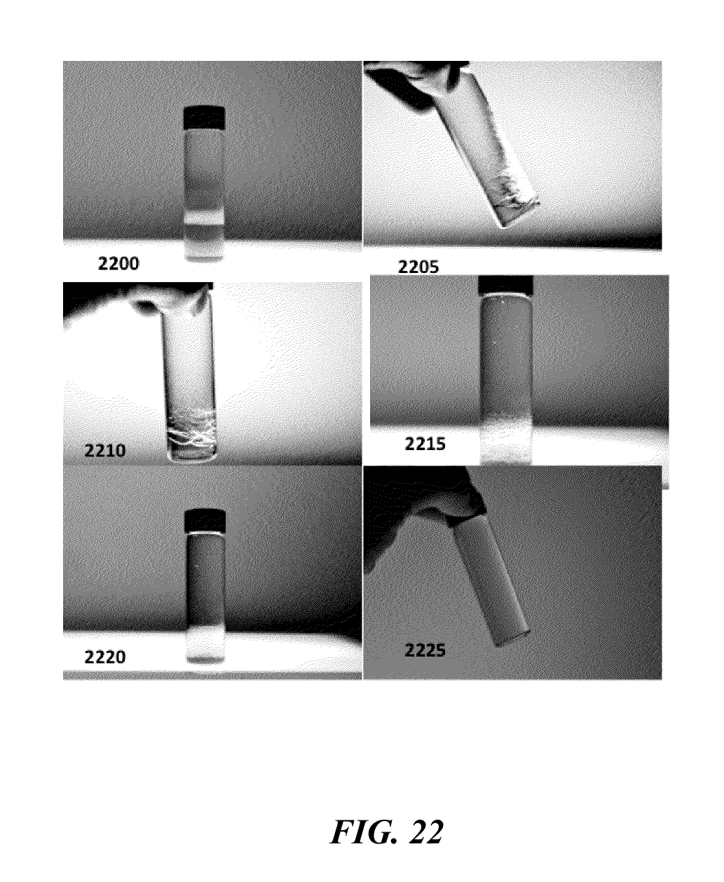

An 8 ml solution of 90% ionic liquid 1-Butyl-3-methylimidazolium chloride, 5% glucose and 10% water by weight was prepared. Eight (8) ml of water was added to the top of the sample with care taken to maintain an ionic liquid-water-glucose phase on the bottom and a visually immiscible water phase on top. The two phase sample was left to sit for several days. Although the distinct meniscus separating the two phases gradually blurred, the top portion of the sample vial remained clear with a darkening yellow gradient toward the bottom portion of the vial. Frame A of FIG. 22 shows the undisturbed sample after a few days where the meniscus is beginning to blur.

The sample vial was then gently rotated about a horizontal axis allowing the clear top and yellow bottom to mix. During this rotation and mixing, the clear phase and yellow phase did not appear to readily blend to a uniform material. In-homogeneous clear and yellow vanes were visibly apparent. Frames B and C of FIG. 22 depict this inhomogeneous mixing. Upon returning to its original orientation the top portion of the vial generally remained clear and the bottom portion of the vial generally remained yellow. The vial was continually rotated about a horizontal axis for several minutes and this same phenomenon was observed.

The sample was then rapidly shaken for approximately 10 seconds. A similar phenomenon of in-homogenous mixing with vanes of different colors was observed although the vanes were generally finer and shorter. These finer and shorter vanes are depicted in frame D and E of FIG. 22.

The sample was then rapidly and violently shaken several times over several hours whereupon the sample vial eventually took on a uniform homogenous appearance with no color gradients or vanes of apparently different composition. Frame F of FIG. 22 shows the vial after this vigorous mixing over time with a visually uniform composition.

While embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

What is claimed is:

1.-21. (canceled)

22. A method for extracting one or more biomass components comprising: contacting a solution comprising one or more biomass components in an ionic liquid with a fluid, wherein the fluid dissolves at most about 10% (w/w) ionic liquid, and wherein at least some of the biomass components dissolve in the fluid.

23. (canceled)

24. The method of claim 22, wherein the fluid is miscible in the ionic liquid.

25. The method of claim 22, wherein the fluid is a supercritical or near-supercritical fluid.

26.-43. (canceled)

44. A method for recovering biomass components from an ionic liquid, the method comprising: forming a first phase and a second phase from a hydrolyzed biomass composition comprising an ionic liquid, water and one or more biomass components, wherein the first phase comprises an ionic liquid and the second phase comprises water and one or more biomass components.

45. The method of claim 44, wherein the hydrolyzed biomass composition is obtained by hydrolyzing the biomass and/or biomass component in the ionic liquid.

46. The method of claim 44 wherein the biomass component is a sugar.

47. The method of claim 44, wherein the sugar comprises glucose.

48. The method of claim 44, wherein the sugar at least partially stabilizes the second phase.

49. The method of claim 44, wherein the concentration of the water in the hydrolysis reaction is such that the concentration of the sugar in the second phase is near saturation.

50. The method of claim 44, wherein water is added to the hydrolysis reaction at a rate such that the concentration of ionic liquid in the second phase is less than 25% (w/w).

51. The method of claim 44, wherein the composition is pressurized to form the first phase and the second phase.

52. The method of claim 44, wherein the temperature of the composition is reduced to form the first phase and the second phase.

53. The method of claim 44, wherein the composition is contacted with pressurized carbon dioxide to form the first phase and the second phase.

54. The method of claim 44, wherein the hydrolysis of biomass provides solutes that induce the formation of the first phase and the second phase.

55. The method of claim 44, wherein the solutes comprise sugar, oil, methanol, or any combination thereof.

56.-101. (canceled)

102. A fermentable sugar comprising a sugar and an ionic liquid, wherein the mass of sugar is at least 20 times greater than the mass of the ionic liquid, and wherein the sugar is derived from cellulose, hemicellulose, or a combination thereof.

103. The fermentable sugar of claim 102, wherein the sugar comprises at least one component selected from furanics, phenols, ethers, aldehydes, ash, lignin, and lignin derivatives.

104. The fermentable sugar of claim 102, wherein the concentration of at least one of: furanics, phenols, ethers, aldehydes, ash, lignin, and lignin derivatives, or any combination thereof is less than 1% (w/w).
